(19) United States
(12) Patent Application Publication
(10) Pub. No.: US 2014/0279310 A1
(43) Pub. Date: Sep. 18, 2014

(54) Electronic Payment System Operative with Existing Accounting Software and Existing Remote Deposit Capture and Mobile RDC Software

(71) Applicant: KOKOPAY, INC., FORT MILL, SC (US)

(72) Inventors: Glen C. Fossella, Fort Mill, SC (US); Kevin F. Kennedy, Concord, NC (US)

(73) Assignee: KOKOPAY, INC., FORT MILL, SC (US)

(21) Appl. No.: 14/211,110

(22) Filed: Mar. 14, 2014

Related U.S. Application Data
(60) Provisional application No. 61/781,971, filed on Mar. 14, 2013.

(51) Int. Cl. G06Q 20/02; G06Q 40/00

(52) U.S. Cl. CPC G06Q 20/027; G06Q 40/12
USPC 705/30

(57) ABSTRACT

Methods and systems for providing an electronic payment to a payee on behalf of a payer. A transaction management system (TMS) receives payments data from an accounting system. The payments data is processed to determine if a payee has opted-in to receive electronic payments. If so, an electronic payment instruction is generated. If the payee has opted-out or is not in a payee file, a print file is generated for printing a conventional paper check. The payee is notified of the payment and can access the system to view a list of payments and remittance information. The payee can indicate a status for a payment on the list, e.g. accept or dispute the electronic payment. In response to selecting a payment in the payments list, the payee is provided with a view of an electronic check representation generated from the electronic payment instruction. The payer can access the payment status in the system to determine if a payment has been accepted. If accepted, the electronic payment instruction is transmitted to a payment recipient system in the form of electronic check representation.

### CROSS-REFERENCE TO RELATED APPLICATIONS

This application claims benefit of U.S. Provisional Patent Application No. 61/781,971, filed Mar. 14, 2013, entitled “Electronic Payment System Operative with Existing Accounting Software and Existing Remote Deposit Capture and Mobile RDC Software,” the disclosure of which is hereby incorporated herein in its entirety by reference.

### TECHNICAL FIELD

The system described relates generally to financial transactions, and more particularly relates to methods and systems for conducting financial transactions between businesses where payers are provided an automatic system for directing electronic payments to payees that have opted to accept such payments and printing check payments to payees who have not, and also provides payees receiving such electronic payments to review, approve, and automatically deposit them in payees' bank accounts.

### BACKGROUND

Checks are negotiable instruments regulated in the United States under the Uniform Commercial Code (U.C.C.) Articles 3 and 4. Checks are paper instruments that are created using one of two methods:
1. A payer populates variable data onto a preprinted paper check form where the variable data includes the payee, payment amount (both the “legal” amount and the “courtesy” amount), and date of issuance of the check. This method may be accomplished by handwriting or typing the variable data into the check form or using computer software programmed to print the data on the appropriate locations on the check form.
2. A payer uses a software program, commonly referred to as “check writing software” that prints all above-mentioned variable data plus all static information needed to create the check form: payer name and address, bank account and routing numbers, legal amount and signature lines, courtesy amount box, and border of check form. In this method, the software outputs the print job to a computer printer using paper stock designed for checks (this is specialized paper that embeds security features such as complex backgrounds, watermarks, and tamper-resistant inks, etc.).

Businesses create checks using either of these methods. When businesses pay other businesses, often a single check is created to pay for multiple services or product shipments received from the payee during a given period (the previous month for example). Creating a single check to pay and receive payment for multiple services or product shipments is a common practice that affords efficiency to both parties.

In these cases, a single check is created by the payer as well as a printed list of the services or product shipments covered by the payment. This list is commonly known as remittance information, payment details, payment stub, or similar term. The check and the remittance information are mailed together and the payee uses this information to reconcile the payer's outstanding payments.

Many businesses use accounting software systems to track sales to payers and purchases from payees. When businesses create check payments (including the remittance information), they use their accounting system to generate the payment instructions. These instructions either control the printing of the check and payment stub onto preprinted checks (method 1 above) or are sent to check writing software which controls the printing of the check and payment stub onto blank check stock (method 2 above).

In addition to the process of creating the check payments, the use of paper checks introduces many other manual steps in the overall payment process for both payers and payees.

As discussed above, the check and payment stub are mailed by the payer to the payee. Upon receipt of these documents, the payee must compare the payment amount and remittance details to the open invoices for the payer and confirm the invoice and payment details. This is typically done by comparing the payment stub to the payer open invoice information in the payee's accounting software system, and approving (applying) the payment of specific invoices.

Once this approval process is complete, the payee deposits the check in their bank account. Depositing is accomplished by one of the following means:
1. Physically going to a bank branch and presenting the check to a bank teller for deposit.
2. Using a method commonly referred to as remote deposit capture (RDC) wherein a specialized “check scanner” creates an electronic image of the check and transmits the image and payee account information to the payee's bank. This method uses commercially-available check scanners, RDC software provided by the bank to the payee, Internet connectivity, and bank server software to enable the transmission process.
3. Using a method commonly referred to as mobile remote deposit capture (mobile RDC) wherein the payee uses a smartphone camera to create an electronic image of the check and transmits the image and payee account information to the payee's bank. This method uses commercially-available smartphones, smartphone “app” software provided by the bank to the payee, cellular data connectivity, and bank server software to enable the transmission process.

Many businesses desire methods of making, accepting, applying, and depositing payments that are more automated. Additionally, business want to accelerate payment processing and have greater visibility and control over the payment process in order to speed account credit and availability of funds. According to one or more prior approaches, there are several methods available for payers to electronically create a payment and deposit it directly into the payee's bank account. These approaches include debit or credit card payments, wire transfers, and Automated Clearing House (ACH) payments. However these approaches exhibit the following shortcomings:
1. No integration with legacy paper-based payments. In many cases, the payees must manage which customers get a paper or electronic invoice, and payers must manage which vendors get a check or an electronic payment. This puts the burden on payers and payees to manage two separate but parallel systems for paper check payment trading partners and electronic payment trading partners.
2. Separate handling of remittance information. In these electronic direct payment approaches, the remittance information that accompanies a traditional paper check payment is handled through a separate process. This makes the payee's Payment Approval process asynchronous from the payment deposit. In many cases, neither the payer nor payee knows whether or when the payment was actually deposited; confirming deposit requires significant manual effort, calling bank representatives, checking online statements, et cetera. Also, if the payer “short pays” the payee due to receiving damaged goods or a discrepancy over what was delivered, the process of disputing and settling these discrepancies, transacting additional payments or credits to settle the dispute, and reconciling the additional transaction in their respective accounting systems can be unwieldy for both the payer and payee.
3. Cumbersome aspects of managing information between payers and payees. In these electronic direct payment methods, for each payer-payee relationship, there is a significant administrative burden in setting up and maintaining accounting software system details and mutual bank account details necessary to transact payments. Managing and maintaining this information is typically a manual activity within an online system.
4. No “network effect”. These approaches are often hub-and-spoke arrangements where both payer and payee must subscribe to the same system in order to facilitate transactions. So the value of any given network is limited to the number of trading partners one has in that network. In order for any of these approaches to be worth the added time and effort described in #1, #2, and #3, either a large number of trading partners must subscribe to a given network, or a business must belong to—and maintain their account with—several networks. This creates a chicken-and-egg problem limiting the acceptance of any given provider's approach.

Therefore, the present applicants believe there is a long-felt but unresolved need for a system or method that manages both paper and electronic payments seamlessly, wherein businesses can pay each other electronically without having to change their current paper payment processes or implement new processes to accommodate electronic payments. The applicants further believed there is a need for a system or method that integrates the electronic payment and payment remittance details, wherein payment and remittance details are delivered together in electronic form to payees thus enabling them to easily review and accept such payments based on remittance details, and deposit them electronically in a straightforward fashion. The applicants further believe there is a need for a system or method that allows businesses to pay each other faster, with shared visibility over the status of payments and the capability to resolve payment disputes quickly and simply. The applicants further believed there is a need for a system or method that enables payers and payees to adopt and use such electronic payment system incrementally and without additional maintenance burdens or costs, while also eliminating the need to subscribe to different schemes in order to pay or receive payments electronically.

### BRIEF SUMMARY OF THE DISCLOSURE

Briefly described, and according to one embodiment, aspects of the present disclosure generally relate to methods and systems for conducting financial transactions between businesses. A transaction management system (TMS), as described herein, relates to methods and systems whereby payers may opt-in (enroll) to use an automatic system for directing electronic payments to payees that have opted to accept such payments while also printing check payments to payees who have not opted in, and also provides payees receiving such electronic payments a system to review, approve, and automatically deposit such payments in payees' bank accounts.

Aspects of the system are embodied in personal computers, smartphones, tablets, and servers, software for personal computers, smartphones, tablets, and servers (e.g. in the form of computer-implemented methods), in an Internet- or cloud-based system for record storage and information transport, in software for financial transaction systems (e.g. in the form of computer-implemented methods), in systems that combine aspects of personal computers, smartphones, tablets, and servers and transaction management systems (TMS), and in software for such systems (e.g. in the form of software for personal computers, smartphones, tablets, and servers and related systems that effect computer-implemented methods).

In one aspect, the system described makes use of functions inherent in the opted-in payer's existing financial accounting software (such as QuickBooks, Sage, etc.) to extract a data table of all records of opted-in payer's payees in the accounting software system, and maintain at all times a separate and synchronous table of these records. Further, this table is extended to store additional information about each payee that is used for the proper functioning of the TMS. This additional information includes but is not limited to whether a payee has opted-in to receive an electronic payment from the TMS, or opted-out, in which case indicating the payee wishes to receive traditional printed paper checks and associated payment stubs.

In another aspect, the opted-in payer uses their existing financial accounting software to generate a check payment file which contains payment instructions for generating check payments to multiple payees, and also for each included payee the payment stub information related to one or more open invoices. But rather than the existing method where the financial accounting software is configured to direct this check payment file to a standard operating system print driver for printing checks on a printer, the financial accounting system is configured to direct the check payment file to the TMS Print Processor. The Print Processor resides locally on the opted-in payer's personal computer or server as a local software application and behaves similar to a standard operating system print driver in how it interacts with the accounting software system.

In one embodiment, the Print Processor monitors the print queue for new check run files generated from the accounting software system and intercepts such files for processing, using the data table of the opted-in payer's payees described above. For each payment in the check payment file generated by the software accounting system and intercepted by the Print Processor, the Payment Decisioning module segregates the payment instructions by payee into two separate payment files based on whether a payee has or has not opted-in to receive an electronic payment, as follows:
Reading each record in the check payment file, payment data for opted-out payees is appended to a new check payment file (in a data structure identical to the original check payment file generated from the accounting software system). The payment data in the record (whether opted-in or opted-out) is then transformed, appended, and buffered (stored temporarily) by the Payment Transform in a data structure of payment instructions that conforms to the TMS Payment Records database (DB). Each payment instruction record is flagged to indicate whether the payment is for an opted-in or opted-out payee.
The new check payment file is sent to the standard operating system print driver for the opted-in payer's printer and those payments are printed as traditional paper checks (this process replicates the check payment function of the payer's accounting software system as used without the system described).
The records in the buffered file containing the transformed data of all payments from the original check payment file are then stored in the TMS Payment Records DB. These records include the flag indicating whether a payment is for an opted-in or opted-out payee. For the newly transformed and stored opt-in payment instructions, a subset of payment instruction elements is saved to a file and sent to the Payment Transport for processing and transmission of new-payment notices to opted-in payees.

In another aspect of the system described, upon receipt of the subset of payment instruction elements from the Payment Transform, the Payment Transport parses the file into separate electronic payment notices by payee and then transmits each payment notice to the appropriate payee.

In a related aspect, prior to being sent to a payee by the Payment Transport, each electronic payment notice is hashed using current best practices to prevent unintended alteration of the notice prior, during, and after transmission to each payee. It is also encrypted using current best practices to prevent theft of the information prior to or during transmission to each payee.

Another aspect of the system described involves providing for an opted-in payee to receive each payment notice. Payment notices are received from the Payment Transport by the opted-in payee individually for each electronic payment as it is sent from various opt-in payers. The system provides for these notices to be stored as received.

In a related aspect, the opted-in payee is notified in real time as each payment notice is received. Exemplary methods of notification include short message service text (SMS), smartphone app alert, email, smartphone instant message (Skype or similar), and personal computer instant message (Skype or similar).

According to another aspect, when an opted-in payee receives one or more new payment notices, they may open the complete payment instructions associated with each notice using the TMS Payment Viewer to review and approve payments. The Payment Viewer presents information regarding opted-in payers' electronic payments to the opted-in payee on the opted-in payee's computer display in tabular form in a left-hand column on the display. The opted-in payee may review this list of payments and select them for further action.

In a related aspect, using the system's Dynamic Rendering function, when an opted-in payee selects a specific payment in the left-hand column, the details regarding the selected payment are immediately displayed in a large rectangular area to the right of the column. The details are rendered on the display as if the opted-in payee were viewing a traditional paper check payment. In other words, the payment instructions for the selected payment are displayed visually as an image of a traditional paper check, an exemplary embodiment being the check on the top third of the “page” and payment stub details below. Dynamic Rendering is used for two purposes:
The generated image acts as a metaphor that simplifies use of the system by allowing users to view electronic payment instructions as they would a traditional paper check and payment stub.
The generated image is used for RDC or mobile RDC submission to the opted-in payee's financial institution or payment processing intermediary (described below in a separate aspect).

In a related aspect, using the Payment Approval module, the opted-in payee indicates which payments are acceptable for deposit by selecting from a drop-down list displayed next to each payment listed in the tabular left-hand column.

In yet another aspect, once review and acceptance is complete using the Payment Approval module, the Deposit Transform module is used to deposit the accepted payments. The system accomplishes this by using the opted-in payee's bank's RDC or mobile RDC functions to make the deposit, providing necessary fielded data and the check image. Unlike the current methods used for RDC or mobile RDC, the system does not scan or photograph a paper check for payment submission, but rather uses the visual representation of a check generated by the Dynamic Rendering module.

From the foregoing, those skilled in the art will understand and appreciate that with its various aspects for personal computers, smartphones, tablets, and servers, software for a transaction management system, Internet- and cloud-based services, and combinations of functionality, a system constructed in accordance with aspects of the system provides users with convenience and flexibility in conducting financial transactions between businesses, including such processes as automatically accepting payment instructions from an accounting software system, segregating payments into those payees opted-in to receive electronic payments from those that wish to receive paper checks, generating and processing payments to such opted-in payees including securely transmitting electronic payment notices to opted-in payees, providing an automated method for opted-in payees to review such electronic payments including an electronic visual rendering of the payment information as a check and payment stub for purposes of reviewing and accepting such payments, and an automated method for depositing approved payments into the opted-in payee's bank account, the means of transmission and deposit being integrated with RDC and mobile RDC bank systems, that have heretofore not been possible at reasonable economic cost and convenience.

These and other aspects, features, and benefits of the system(s) described will become apparent from the following detailed written description of the preferred embodiments taken in conjunction with the following drawings, although variations and modifications thereto may be effected without departing from the spirit and scope of the novel concepts of this disclosure.

### BRIEF DESCRIPTION OF THE DRAWINGS

The accompanying drawings illustrate one or more embodiments and/or aspects of the disclosure and, together with written description, serve to explain the principles of the disclosure. Wherever possible, the same reference numbers are used throughout the drawings to refer to the same or like elements of an embodiment, and wherein:

FIG. 1 illustrates a high-level lifecycle of an exemplary payment transaction, including check run interception, payment decisioning, opted-in payee notification, and opted-in payee payment review and deposit according to one embodiment of a transaction management system (TMS) constructed in accordance with the present disclosure and certain aspects of the inventions;

FIG. 2 illustrates a high-level overview of one embodiment of a transaction management system (TMS) and its associated elements and connections, according to one aspect of the disclosure;

FIG. 3 shows one embodiment of a system architecture for a transaction management system (TMS) according to an aspect of the disclosure;

FIG. 4 is a flowchart illustrating the overall process of on-boarding (enrolling) new users to a transaction management system (TMS);

FIG. 5 is an exemplary opt-in/opt-out table illustrating data utilized to categorize and identify payees and payers as opted-in or opted-out to use a transaction management system (TMS), such data being acquired from opted-in payer and payee accounting software systems respectively;

FIG. 6A is a flowchart illustrating the check run print file interception and opt-in/opt-out payment segregation according to one embodiment of the present transaction management system (TMS);

FIG. 6B is a flowchart illustrating a check run print file interception and opt-in/opt-out payment segregation according to an alternative embodiment of the present transaction management system (TMS);

FIG. 6C is a flowchart illustrating the payment data transform and storage process according to an embodiment of the present transaction management system (TMS);

FIG. 6D illustrates an exemplary screen capture of a graphical user interface (GUI) associated with a new payment notification to a opted-in payee, using email as the transport method and displayed therein according to an embodiment of the present transaction management system (TMS);

FIG. 7 is an exemplary screen capture of transaction records as illustrated in a payment records database table including identifiers associated with matched opt-in and opt-out transactions as a result of an opt-in/opt-out payment segregation process as shown in FIGS. 6A, 6B, and 6C according to an embodiment of the present transaction management system (TMS);

FIG. 8 is an exemplary screen capture of a graphical user interface (GUI) associated with an embodiment of a Payment Viewer, wherein a tabular display of payment records is presented whereby a user selecting a payment record invokes a Dynamic Rendering module of a transaction management system (TMS) to generate a visual representation of a check and check stub (remittance information) based on the payment instructions related to a user-selected payment record;

FIG. 9 is a flowchart illustrating the process described in FIG. 8 for dynamically rendering an image of a check and check stub (remittance information) in a Payment Viewer based on the payment instructions related to a user-selected payment record according to an embodiment of the present transaction management system (TMS);

FIG. 10 is a flowchart illustrating a Payment Transport notification and Payment Approval process according to an embodiment of the present transaction management system (TMS);

FIGS. 11A, 11B, and 11C, are a series of exemplary screen captures illustrating the functions of a graphical user interface (GUI) associated with a Payment Viewer, along with matching exemplary transaction tables associated with the processing of a Payment Approval module, wherein an opted-in payee selects a payment record in the Payment Viewer and changes its status, whereby the transaction table updates to reflect the opted-in payee's actions, and the corresponding opted-in payer's view of the payment record in the Payment Viewer is updated in real-time according to an embodiment of the present transaction management system (TMS);

FIG. 12 is a flowchart illustrating an embodiment of a generalized process for transforming one or more TMS Payment Records into a structure suitable for deposit using a bank's RDC or mobile RDC functions and executing such deposit according to an embodiment of the present transaction management system (TMS);

FIG. 13 illustrates an exemplary transaction management system (TMS) hardware architecture upon which an embodiment of the TMS may be implemented as herein described.

### DETAILED DESCRIPTION

Prior to a detailed description of the disclosure, the following definitions are provided as an aid to understanding the subject matter and terminology of aspects of the present systems and methods. These definitions are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapi-talized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### DEFINITIONS/GLOSSARY

Accounting system: software that records and processes accounting transactions within functional components including accounts payable and accounts receivable.

Accounts payable (AP): in software, a sub-component of an accounting system for recording invoices received from payees, dispensing payments to payees, and balancing and reconciling such payments. These systems typically include functionality for generating payments as printed checks in batches, also known as “check runs”. Such payments commonly include each check and the Remittance Information aggregating the invoices being paid, printed in a series of one or more printed pages.

Accounts receivable (AR): in software, a sub-component of an accounting system for recording sales to payers, generating payment notices to payers in the form of invoices, applying payments received from payers, and balancing and reconciling such payments. These systems typically include functionality for generating printed invoices in batches or storing them electronically and emailing them to payers. Payments received from payers in the form of checks with Remittance Information must be applied to open invoices in the accounting system. Additionally, as checks are deposited in the payee's bank account, they must be reconciled in the AR system to close each invoice.

Automated Clearing House (ACH): an electronic banking network that processes volumes of credit and debit transactions in accordance with rules and regulations established by the National Automated Clearing House Association (NACHA) and the U.S. Federal Reserve (Fed or FRB).

Application: a computer program that operates on a computer system, e.g., but not limited to, a computer program operated within the TMS, or a computer program operated within a personal computer, server, mobile phone, tablet or other computing device. Further examples of applications include programs that perform a search in a database, receive and store information in a temporary memory of a personal computer, server, mobile phone, tablet or other computing device, display selected information on a personal computer, server, mobile phone, tablet or other computing device, etc., and virtually any other type of program that generates transactions or is responsive to transactions.

App/phone app (generally synonymous with mobile application): a computer program that operates on a mobile computer system, e.g., but not limited to, a computer program operated within the TMS, or a computer program operated within a mobile phone, tablet or other mobile computing device.

Applet: a computer program that operates on a personal computer, typically memory-resident and active at all times that the computer is operating, e.g., but not limited to, a computer program operated within the TMS.

Application programming interface (API): a set of functions that conform to conventions of a particular operating environment (e.g., Windows, SOAP, .Net) which allows the user to programmatically access the functionality of another program. In an exemplary aspect of the system, the TMS can apply Remittance Information directly into the opted-in payee's AR system. In another exemplary aspect, the TMS can send payment instructions directly to the opted-in payee's FI RDC system or mobile RDC system to complete a payment deposit.

Bill presentment: the presentation or presentment of one or more payment obligations of an entity either as a printed and mailed invoice or as an electronically stored and emailed invoice.

Bluetooth: a collection of computing devices including but not limited to mobile devices, laptops, desktop computers, entertainment equipment, that are connected for electronic communications through a wireless radio signal, typically located in close proximity to each other (that is, within a few dozen meters).

Bluetooth low energy (BLE, Bluetooth beacon): a collection of computing devices including but not limited to mobile devices, laptops, desktop computers, entertainment equipment, that are connected for electronic communications through a wireless radio signal, typically located in close proximity to each other (that is, within a few feet).

Database (DB): information stored in a specific structure or sets of structures e.g., but not limited to, information stored and accessed by the TMS.

Database management system (DBMS): a system used to store, retrieve and manage information.

Enterprise: an organization or business entity that utilizes the system(s) described herein. An Enterprise can be a business, a government agency, a person, or virtually any other organization that conducts payment transactions reflective of its normal activity.

Financial institution (FI): an entity, such as a bank or credit union, that provides financial services on behalf of its customers. As used herein, an FI is a payment instruction recipient for the purposes of depositing payments on behalf of opted-in payees or making payments on behalf of payers.

Franking: the act of writing or printing a message across the face of a check. Today, typically “ELECTRONICALLY PRESENTED” is printed on the front of the original check to indicate it has been remotely deposited and that the paper check is now void and should not be deposited in physical form.

Graphical user interface (GUI or UI): typically refers to a software application with which a User interacts for purposes of entering information, obtaining information, or causing functions of an associated system to execute.

Good funds: in banking, refers to monies in a bank account that are usable immediately by the owner of the account, or such availability being guaranteed by said bank or other entity.

Invoice: information provided by a billing entity such as a payee, relating or corresponding to a bill to be paid; typically consists of all information provided by the billing entity that would appear on a bill to be paid and provided to a user or payer.

Local area network (LAN): a collection of computers that are connected for electronic communications, typically located geographically close together (that is, in the same building).

MICR line/MICR data line: the routing number and account number printed at the bottom of a check. MICR characters employ a special font and magnetic characteristics to facilitate machine reading of the numbers, but they are also human readable.

Mobile device: any device used for communication over wireless communication networks, such as a mobile phone or tablet. Mobile devices operative in the present system typically run a mobile client software program (see App/Phone App) to effect the functionality described herein.

Mobile remote deposit capture (mobile RDC): the ability to deposit a check into a bank account from a mobile phone, without having to physically deliver the check to the bank. This is typically accomplished by using the camera function on the phone to photograph the front and rear image of a check, providing a User ID in the phone app, then transmitting the images to the bank, a practice that became legal in the United States in 2004 when the Check Clearing for the 21st Century Act (or Check 21 Act) took effect.

Operating system: a collection of software that manages computer hardware resources and provides common services for computer programs. The operating system is an essential component of the system software in a computer system. Application programs such as accounting software usually require an operating system to function.

Opted-in payee, opted-in payer: as embodied in these system(s), a Payee or Payer enrolled or subscribed to use the TMS or having access to functions of the TMS. See also User, TMS user.

Opted-out payee, opted-out payer: as embodied in these system(s), a Payee or Payer not enrolled in, subscribed to, or making use of the TMS for making or receiving payments.

Payee: a person or an entity receiving payment. A payee may also be a payment instruction recipient.

Payee bank (payee's bank, bank of first deposit, BOFD): the financial institution in which payments are deposited. Deposited checks must then be presented to the Payer Bank for clearing and transfer of funds from the payer's bank account to the payee's bank account.

Payer: a person or an entity making a payment. A payer may also a person or an entity sending a payment instruction.

Payer bank (payer's bank, payor bank): The bank on which checks are written from a payer's account and from which funds are drawn for clearing and funds transfer to a Payee Bank.

Payment instruction (PI): In accordance with exemplary aspects of the system(s) described herein, a collection of information that typically includes the payment amount and instructions for completing the payment from an opted-in payer's financial institution. Payment instructions may also include the Remittance Information associated with the payment to enable an opted-in payee to apply and reconcile the payment within their Accounting System's AR function. In an additional exemplary aspect, a collection of information that typically includes the payment amount and instructions for depositing the payment with the opted-in payee's financial institution using the FI's RDC or mobile RDC functions, together with dynamically rendered images of the front and back of a check containing information relating to the payment.

Payment method: the manner in which a payment is provided to a payee by a payer or its agent, i.e. a financial instrument of some sort provided to a payee; a payment can be made by various means including but not limited to paper check, stored value card, ACH funds transfer, a credit or debit card, wire transfer, money order, credit to a PayPal or other online financial account, another type of financial instrument, etc.

Payment processing intermediary: an entity that provides financial services including but not limited to receiving, processing, and clearing payments on behalf of its customers such as a bank or credit union. As used herein, a payment processing intermediary acting on behalf of an FI as a payment instruction recipient for the purposes of depositing payments on behalf of opted-in payees or making payments on behalf of opted-in payers.

Payment records: as embodied in these system(s), all payments generated by opted-in payers using the system from their Accounting System AP function. The TMS retains payment instructions for payment as well as the current status of each payment.

Point-of-sale system (POS): A computerized system at which a customer makes a payment to the merchant in exchange for goods or services. The system typically calculates the amount owed by the customer and provides options for the customer to make payment, including cash, credit or debit card, and check. The system will also normally issue a printed receipt for the transaction.

Print driver: software that converts the data to be printed to the form specific to a printer. The purpose of print drivers is to allow software applications (such as Accounting Systems) to print documents without being aware of the technical details of each printer model.

Print processor: as embodied in these system(s), a facility for monitoring the print queue, intercepting print files from the user's software accounting system that contain check runs, and processing said check run payments for either electronic delivery or paper check printing. For payments intended for payees that are opted-in to the system, payment details are extracted from the check run print file, transformed into the TMS data structure, and stored as payment instructions for opted-in payee review and eventual deposit. For payments intended for payees that are opted-out of the system, payment details are rebundled into a new check run print file and sent to the user's print driver for printing as traditional checks and stubs.

Print queue: software that stores print files or jobs on a computing system for management and output to one or more printers attached to the computing system. A print queue gives users printer management capabilities to facilitate control of printing operations such as pausing, resuming or canceling print jobs.

Remittance/remittance information: information describing in aggregate the invoices and invoice amounts due to be paid, or being paid as part of a specific Payment Instruction, e.g., but not limited to, check stub, stub information, payment stub.

Remote deposit capture (RDC): the ability to deposit a check into a bank account from a remote location, such as an office, without having to physically deliver the check to the bank. This is typically accomplished by scanning a digital image of the front and rear image of a check into a computer, then transmitting the images to the bank, a practice that became legal in the United States in 2004 when the Check Clearing for the 21st Century Act (or Check 21 Act) took effect.

Rendering/dynamic rendering: as embodied in these system(s), the dynamic generation of a visual representation of a check, including both front and back images, and specific information derived from a Payment Instruction including but not limited to the opted-in payer's bank account number, signature, date of payment, and payment amount, to complete the representation. In an additional embodiment, the dynamic generation of a visual representation of a check as above, and the payment stub including Remittance Information derived from Payment Instructions including but not limited to the invoice number(s), description of the product(s) or service(s) that was invoiced, and the invoice amount(s), to complete the representation.

Transaction: a set of system actions that result in a completed business activity. The following are exemplary transactions: the transfer of a certain amount of money (funds) from a payer to a payee; the transfer of remittance information from a payer to a payee to facilitate the application of a payment in an accounting system; the transfer of a certain amount of money (funds) from a payee to the payee's bank account using the methods described in this document.

Transaction management system (TMS): overall system described herein for managing paper and electronic payments between businesses and performing a host of other tasks and processes as described in detail herein. Generally includes a system for intercepting sand decisioning check run print files to determine whether the payee is opted-in to receive electronic payments from the TMS, a facility for the opted-in payee to review and approve payments for deposit, including a method for dynamically selecting and reviewing an on-screen rendering of the check payment and stub generated from the payment instructions, and a method for transforming said payment instructions into a data structure, including the rendered front-and-back images of a check associated with the payment instructions, suitable for electronic deposit in the opted-in payee's bank account and executing said deposit.

Till: in a retail store, a storage area for physically storing cash and checks. A till is typically integrated with a cash register or point-of-sale computer operated by a cashier or sales clerk. Also referred to as a cash till or cash drawer.

SMS: short message service, a text communication service available on many mobile devices that permits the sending of short messages (also known as text messages, messages, or more colloquially SMS′, texts, or txts) between mobile devices. In the context of the system(s) described herein, a system that permits the sending of short messages as transaction-enabling alerts.

Skype: a text, audio, and video communication service available on personal computers and many mobile phones and tablets. In the context of the system(s) described herein, a system that permits the sending of short messages as transaction-enabling alerts.

Transaction management system (TMS): a system constructed as described in this document, which facilitates financial transactions between payers and payees opted-in to use the TMS and their financial institutions.

TMS payment instruction (TMSPI): a form of Payment Instruction (PI) (see above) that comprises a communication initiated by the TMS and transmitted to a payment instruction recipient such as a opted-in payee for review and approval of a payment, or the opted-in payee's financial institution to instruct that institution to deposit the payment using the methods described in this document.

User: an individual or other entity that accesses or uses a personal computer, mobile phone, tablet, or other computing device, to perform certain functions of a transaction management system. See also Opted-in Payer or Opted-in Payee. As used herein, these terms are generally synonymous. A user may also use a web interface to access the TMS for configuration and use, as described herein.

User (TMS user): an opted-in payee who receives payments and makes deposits using the TMS or opted-in payer who makes payments using the TMS.

User identifier (user ID): a code used to identify a user to the TMS, a financial institution, or other system or entity that requires information identifying a user for some purpose in connection with the system.

Wide area network (WAN): a collection of computers that are connected for electronic communications, typically where the computers are further apart than a LAN and are connected by telephone lines, fiber optic cables, satellite transmission, or radio waves.

Wireless local area network (WLAN): a collection of computing devices including but not limited to mobile phones, tablets, laptops, desktop computers, entertainment equipment, that are connected for electronic communications through a wireless radio signal, typically located geographically close together (that is, in the same building). Examples include the known WiFi and WiMAX data communication standards.

### OVERVIEW

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for conducting financial transactions between businesses where payers may opt-in (enroll) to an automatic system for directing electronic payments to payees that have opted to accept such payments and printing check payments to payees who have not, and also provides payees receiving such electronic payments to review, approve, and automatically deposit them in payees' bank accounts. Although the description which follows is primarily directed to application of the claimed invention(s) to business payments, it should be understood that the invention(s) have broader applicability to any systems that allow businesses, consumers, governments, or other such entities to conduct financial transactions with and among each other where payers may opt-in to an automatic system for directing electronic payments to payees that have opted to accept such payments, both with and without the need to print check payments to payees who have not, and also providing payees receiving such electronic payments to review, approve, and automatically deposit them in payees' bank accounts.

It should further be understood that the invention(s) have broader applicability to any systems that allow application-generated print files or jobs to be intercepted, and the information contained therein to be disaggregated and normalized for the purpose of taking one or more actions based on the information. Such actions may include but are not limited to, releasing the print job without modification to an operating system print driver for printing, modifying the print job before releasing for printing, such modifications including by not limited to removing certain print records from the print job, modifying one or more print records, inserting new print records, suspending the printing of the print job during processing by a software application separate from the computer software, or storing the data for later use by the computer software or software application separate from the computer software, and these actions may or may not include human interaction or decisions as part of the system(s) processing.

Aspects of the present disclosure are generally implemented using computing devices coupled for electronic communications with a transaction management system (TMS). Computing devices include such items as personal computers, mobile phones, and tablets, which are connected for data communications via a hard-wired or wireless network to a TMS. The TMS is in turn connected to allow remote network access (e.g. Internet access) by users for account setup, system configuration, and conducting, editing, or monitoring of transactions, etc. As will be known by those skilled in the art, such devices are commercially available in various configurations and are essentially computing devices that include features such as a hardwired or wireless signal circuit for LAN connections, WAN connections, WLAN connections, Internet connections, Ethernet connections, etc., a microprocessor as a central processing unit (CPU), a color or other display, a keyboard or keypad, a stylus, touch screen, a scroll wheel, control buttons, etc. The TMS is similarly a general purpose computing device containing one or more processors and/or central processing units (CPU), data storage in the form of disk or solid-state drives and random access memory (RAM), communication interfaces such as LAN connections, WAN connections, WLAN connections, Internet connections, Ethernet connections, etc.

Accordingly, it will be understood that various embodiments of the system described herein are preferably implemented as a special purpose or general-purpose computer including various computer hardware as discussed in greater detail below. Embodiments within the scope of the system also include computer-readable media for carrying or having computer-executable instructions or data structures stored thereon. Such computer-readable media can be any available media which can be accessed by a general purpose or special purpose computer, or downloadable to a mobile device through wireless communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hard-wired, wireless, or a combination of hardwired and wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the system may be implemented. Although not required, the systems will be described in the general context of computer-executable instructions, such as program components, being executed by computers in networked environments. Such program components are often reflected and illustrated by flow charts, sequence diagrams, exemplary screen displays, and other techniques used by those skilled in the art to communicate how to make and use such computer program components. Generally, program components include routines, programs, objects, modules, data structures, etc. that perform particular tasks or implement particular abstract data types, within the computer. Computer-executable instructions, associated data structures, and program components represent examples of the program code for executing steps of the methods disclosed herein. The particular sequence of such executable instructions or associated data structures represent examples of corresponding acts for implementing the functions described in such steps.

Those skilled in the art will also appreciate that the system may be practiced in network computing environments with many types of computer system configurations, including personal computers, hand-held devices, multi-processor systems, microprocessor-based or programmable consumer electronics, networked PCs, minicomputers, mainframe computers, and the like. The system may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Exemplary devices for implementing the system, which are not illustrated in all cases, include mobile phones and tablets, including a processing unit, a system memory, and a system bus that couples various system modules including the system memory to the processing unit, and modules to wireless communication to a network and/or the Internet. The mobile phone or tablet will typically include solid-state storage and/or off-line disk storage (also called “data stores” or “data storage” or other names) for reading from and writing to. These storage methods provide nonvolatile storage of computer-executable instructions, data structures, program modules, and other data for the mobile phone. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules that may be stored on a hard disk or other storage medium. This program code, as is known to those skilled in the art, usually includes an operating system, one or more application programs, other program modules, and program data. A user may enter commands and information into the computer through keyboard, pointing device, touch screen, or other input devices (not shown), such as a microphone, game pad, satellite dish, scanner, or the like. These and other input devices are often connected to the processing unit through known electrical, optical, or wireless connections.

The main computer that affects many aspects of the systems will typically operate in a networked environment using logical connections to one or more remote computers or data sources, which are described further below. Remote computers may be another personal computer, a server, a router, a network PC, mobile phone, tablet, a peer device or other common network node, and typically include many or all of the elements described above relative to the main computer system in which the systems are embodied. The logical connections between computers include a local area network (LAN or WLAN), Bluetooth or Bluetooth low energy (BLE) connection, and a wide area network (WAN) that are presented here by way of example and not limitation. Such networking environments are commonplace in shared-public, home-wide, office-wide or enterprise-wide computer networks, intranets and the Internet.

When used in a LAN or WLAN networking environment, the main computer system implementing aspects of the system is connected to the local network through a network interface or adapter. When used in a Bluetooth or Bluetooth low energy environment, the main computer system implementing aspects of the system is connected to other computer systems through a Bluetooth interface or adapter. When used in a WAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the connections described or shown are exemplary and other means of establishing communications over local or wide area networks or the Internet may be used.

### Description of Transaction Management System, Components, and Processes

### Exemplary Payment Transaction Lifecycle

With the foregoing implementation architecture in mind, and for the purposes of example and explanation of the fundamental processes and components of the disclosed systems and methods, reference is made to FIG. 1, which depicts a high-level lifecycle, 100 of an exemplary payment transaction according to one embodiment of a transaction management system (TMS) constructed and operated in accordance with various aspects of the claimed invention(s). As will be understood and appreciated, the example lifecycle shown in FIG. 1 represents merely one approach or embodiment of the present system, and other aspects (e.g., print processing, decisioning, and transform, payment notification, dynamic rendering, payment approval, and deposit are not based on singular transactions, but on a series or pattern of transactions) are used according to various embodiments of the present system.

As shown in the lifecycle 100, a process for a payment transaction commences when an opted-in payer 101 (e.g., a user of the TMS), using standard accounts payable (AP) functionality in their accounting software system, selects several invoices to be paid for various payees, then initiates the payment process by executing a “check run” print job using the accounts payable functionality in their accounting software system 102. Under typical conditions, this would result in a print file being sent to an operating system (OS) print queue and then an OS print driver, which would control the printing of checks and stubs (remittance information) on the user's printer.

In one embodiment of the system, the TMS Print Processor 103 monitors the user's computer's print queue, and identifying a new print file entering the queue from the accounting system, inspects the print file to determine whether it is a check run. If it is not a check run, the print queue is allowed to send the file to the print driver for normal printing. If it is a check run, the file is intercepted and not allowed to print. The file is then forwarded to the TMS Payment Decisioning module 104 which, based on a mapping of the specific check run print file, extracts and inspects the data elements of each payment record in the print file and compares the payee information from the record to payee information in the TMS Opt-In/Opt-Out database (DB) (see FIG. 3 for a detailed explanation of the Opt-In/Opt-Out database and related aspects of the system according the present embodiment). This determines whether or not the payee has opted-in (enrolled) to the TMS for the purpose of receiving electronic payments and remittance information in lieu of check payments and stubs.

For each payment record associated with an opted-out payee, the Payment Decisioning module 104 appends the original payment record to a new check run print file. At the completion of the decisioning process, the new check run file is directed to the operating system (OS) print queue 105 for processing and printing of paper checks with payment stubs, and eventual mailing and delivery to opted-out payees 106.

Having extracted the data elements of each payment record from the original print file, the Payment Decisioning module 104 passes said data elements to the TMS Payment Transform 107 which then transforms the data elements of each payment record to conform with the structure of the TMS Payment Records database (DB) database (see FIG. 3), and stores each record in said database as payment instructions for further processing. Also, based on the decisioning in the Payment Decisioning module 104, the Payment Transform 107 appends the payment instructions for each record to indicate whether the payment record is associated with an opt-in or opt-out payee.

Following this step, a subset of the payment instruction data elements for newly-transformed and stored opted-in payment records DB are extracted by the Payment Transform 107 and formatted as individual payment record notices for transport to each respective opted-in payee. These notices are parsed, hashed and encrypted using current best practices to ensure secure control over the data. Then each notice is transported by the TMS Payment Transport module (108) to the respective opted-in payee to notify them of one or more available payments for review and approval. Notification is conducted by one or more electronic means based on the preferences of the opted-in payee. Such means include but are not limited to email, SMS text message, Skype message, applet running on a personal computer, or app running on a mobile device.

Still referring to FIG. 1, upon receiving one or more payment record notices, an opted-in payee 110 may access the payment instructions through the functionality of the TMS Payment Viewer 111 for reviewing and approving payments. These functions may be launched from the user's preferred electronic notification method (for example, a link in an email to a web browser session of the Payment Viewer, or a function within a TMS mobile phone app) or directly (for example, launching the functionality by opening a web browser session, navigating to a TMS log-in page and logging in to access the Payment Viewer). In all cases, it will be understood and appreciated that users are accessing the Payment Viewer and other TMS GUIs from the Internet cloud via a web browser or mobile phone/tablet app.

Within the Payment Viewer 111, the GUI presents a tabular display of the opted-in payee's payment instructions. One skilled in the art will appreciate that information in the tabular display may be filtered, reordered, or otherwise manipulated to present a view of the information best suited to the user's then-current needs. In another aspect of the system, the Payment Viewer's tabular display provides a drop-down selection function that invokes the Payment Approval module 112, which allows the opted-in payee to process payments automatically by changing the status of a payment record. The opted-in payee may approve or reject a payment, or leave it open pending further review.

In one aspect of the system, when the user selects a specific payment, the TMS invokes the TMS Dynamic Rendering module 109, which renders in real-time the payment instruction data into a generic image of a check side-by-side the tabular display within the Payment Viewer 111 (see FIG. 8 for a screen capture that provides an exemplary representation of this aspect). The user may “toggle” the view of the front and back of the check. Additionally the Dynamic Rendering module also renders the remittance information (invoice number, description of the invoice, invoice amount due) contained in the payment instructions to create a complete visual representation of a paper check payment including the check and payment stub. This virtual analog of a check and stub allows the opted-in payee to review the payment details in a form that they are most accustomed, thus easing the transition from a paper-based accounts receivable process to an electronic one.

In another aspect, using the Payment Viewer module 111, opted-in payers may review the status of payments they have made to opted-in payees. As the opted-in payee changes the payment status in the Payment Viewer tabular display 111, the change is dynamically updated in the payment records DB and also in the opted-in payer's view of the payment record. Not only does this allow opted-in payers to better plan payments and cash flow, it also enables opted-in payers and payees to collaborate more effectively on resolving disputes and negotiating the timing of payments.

Once an opted-in payee has determined whether to approve certain payments, the opted-in payee can elect to process those payments for deposit in their bank (Payee Bank) 114. In this aspect of the system, when the opted-in payee changes the payment status to “Deposit” payee in the Payment Viewer 111, the Payment Approval module 112 invokes the Deposit Transform module 113, which prepares the payments for deposit by transforming the payment instructions for such deposits into a file suitable for acceptance by either the Payee Bank's remote deposit capture (RDC) or mobile RDC server (the choice of either deposit method will depend on several factors including but not limited to which method is available from a given Payee Bank). This process includes using the Dynamic Rendering module 109 to generate permanent representations of both front and rear images of a generic check based on the payment instructions. Additionally, certain data elements of the payment instructions are assembled in the specific data structure required by the bank's RDC or mobile RDC functions.

The images and required data elements are then electronically packaged in the appropriate file structure and submitted to the banks' RDC or mobile RDC server using the Deposit Transform module 113. In an exemplary embodiment, this file structure may conform to an electronic cash letter according current or previous ANS X9.37 specifications, or some custom or proprietary structure of the Payee Bank 114, or their RDC or mobile RDC software provider, or their payment processing intermediary. One skilled in the art will understand and appreciate that the Dynamic Rendering-generated check representations may be combined with a variety of data structures that meet the Payee Bank's requirements for RDC or mobile RDC submission. Additionally, it will be appreciated that the required electronic means or protocol of submission may similarly vary by institution.

In another aspect, upon completion of the RDC or mobile RDC deposit, the Payee Bank 114 API sends a notification to the TMS that the deposit has been accepted. Monitoring for this notification, the Payment Approval module 112 automatically changes the payment status record to “deposited”. This status is also dynamically updated in the payment records DB, where it can be viewed by the opted-in payer or payee in the Payment Viewer 111.

In another aspect of the system, the Payment Approval module 112 can automatically apply approved payments to the related invoices in the accounts receivable module of the opted-in payee's accounting system. Also, once the deposit acceptance notification is received from the bank API, the Payment Approval module 112 can automatically reconcile the payments and close the related invoices in the opted-in payee's accounting system.

The Payee Bank 114 then presents the payment to the Payer Bank for funds transfer and clearing. Once the transaction is cleared, the opted-in payer can reconcile the payment in their accounting system 102.

As will be appreciated, all participatory parties benefit from use of the embodiments of the transaction management system. Opted-in payers are given access to a new method of paying their suppliers that is less labor intensive and saves on the cost of check stock, stamps, envelopes and other supplies related to the paper check payment process. Additionally, this method can be implemented with virtually no change to their existing AP processes, nor does it imposed any new processing or maintenance burden, or any additional processing costs such as those paid for ACH payments. Opted-in payees are able to receive, apply and deposit payments from their desks with much less manual effort, including reducing trips to the bank to make check deposits, and may reduce the cost of other deposit services such as RDC check scanning or bank lockbox services. Opted-in payees also benefit from faster payment credit and funds availability, and do so without paying high processing fees as they might with credit or debit card payments.

It will also be appreciated that for both opted-in payer and payee, the Dynamic Rendering module 109 extends the paper check analogy, making adoption and usage of the system fast and easy. The real-time nature of payment status updates in the TMS allows opted-in payers and payees to better plan payments and cash flow, and reduces the time and effort required to resolve payment disputes. The TMS' ability to receive payment confirmation and automate the application and reconciling of payments in the opted-in payee's AR and opted-in payer's AP accounting system modules further reduces manual effort, user errors, and the costs associated with maintaining good accounting practices. Finally, banks benefit from the embodiments of the present systems and methods because accepting TMS payments helps them lower their costs by reducing branch deposit traffic. It also eliminates phone call and email volume from payers and payees related to inquiries regarding the location and status of check and ACH payments.

### Transaction Management System Overview

Summarizing from FIG. 1, it will be understood and appreciated by those skilled in the art that as described in the present embodiment, the TMS enables opted-in payers to manage the processing of their payables as they do today, i.e. by using the functionality inherent in a standard accounting software system, and still deliver both paper check payments to opted-out payees and electronic payments to opted-in payees with no additional effort.

The TMS manages aspects of both payment methods by automatically interceding in the traditional paper check run process and segregating payments designated for opted-out and opted-in payees respectively. For opted-out payees, their payments are automatically reintegrated into the opted-in payer's standard check printing and mailing process; they receive their paper checks and stubs and process accounts receivables in traditional fashion.

For opted-in payees, their payments are delivered electronically, but it will be appreciated that the TMS enables payees to also manage the processing of their receivables as they do today, i.e. by using the functionality inherent in a standard accounting software system. The TMS manages this by providing an on-screen visual representation of the check-and-stub that parallels the traditional paper-check review and payment application process. This enables opted-in payees to process electronic payments in-line with their paper check payments while taking advantage of the speed and efficiency of the TMS electronic deposit capabilities.

Specifically now referring now to FIG. 2, a high-level overview 200 is shown of one embodiment of the transaction management system (TMS) 201 and its associated environment. As shown, the TMS 201 includes a Print Processor 103 which is invoked by an opted-in payee 101 initiating a check run in their accounting software system 102. The Print Processor may be locally connected (although the connection does not necessarily have to be local) to one or more accounting software systems via the network or operating locally on the same computing device as the accounting software. Although the TMS and its components are represented in FIG. 2 as conceptual boxes, the TMS is comprised of system components including one or more databases, software modules, memories, servers, computer readable media, processors, algorithms, portals, and other similar components.

Still referring to FIG. 2, generally, the Print Processor 103 monitors one or more operating system (OS) print queues 105 connected with the accounting system(s). The Print Processor 103 uses pre-built mappings of commercial accounting systems' check run print layouts to inspect each print file as it enters a queue and determine whether it is a check run. These mappings are stored in the Check Run Mappings DB 202. Non-check run print files are allowed to pass to a designated OS print driver for normal printing. If it is a check run, the file is intercepted and not allowed to print. The file is then forwarded to the TMS Payment Decisioning module 104.

A Payment Decisioning module 104, inspects each payment record in the check run print file to determine whether it is intended for an opted-in payee. To accomplish this, it applies the appropriate data map from the Check Run Mappings DB 202 to extract and inspect the data elements of each payment record, and matches the payee information in the record against the TMS Opt-in/Opt-out DB 203, which contains a listing of the opted-in payer's payees including each payee's opt-in/opt-out status. Payment records intended for opt-out payees are appended to a new check run print file.

Once all records have been decisioned, the new check run file (now containing only the opt-out payment records) is directed to the OS print queue 105 which manages and releases the new check run file to the OS print driver 207 for processing and printing of paper checks with payment stubs 205, and eventual mailing 206 to opted-out payees 106.

In the embodiment shown in FIG. 2, having extracted the data elements of each payment record from the original print file, the Payment Decisioning module 104 passes said data elements to the Payment Transform 107 which then transforms the data elements of each payment record to conform with the structure of the Payment Records Database (DB) 204, and stores each record in the database. Based on the decisioning in the Payment Decisioning module 104, the Payment Transform 107 also appends the payment instructions for each record to indicate whether the payment record is associated with an opt-in or opt-out payee.

It will be understood and appreciated from the aforementioned that even though opted-in payees 101 continue to print and mail paper checks to opted-out payees 106 who process and deposit their checks in traditional fashion, opted-in payers 101 are able to view details of both opt-in and opt-out payment records within the TMS. Therefore, in one aspect and depending on the Payer Bank's 212 capabilities, as opted-out payments (paper checks) are deposited, whether directly in Payee Bank branches 209 or via check scanning RDC 208, and then cleared by the Payer Bank 212, the Payer Bank may, through its API, be able to confirm receipt of forward presentment and clearing of these checks to the opted-in payer accounting system 102, which will then update the payment status in the TMS Payment Records DB 204 through the accounting system's API 102. This will then be reflected in the Payment Viewer 111 and afford the opted-in payer 101 visibility into not only the status of electronic payments to opted-in payees 110, but check payments to opted-out payees 106 as well.

For those newly-transformed and stored payment records intended for opted-in payees, a subset of the payment instruction elements are extracted and formatted as individual payment record notices for transport to each designated opted-in payee 110 by the Payment Transform 107. They are then securely transported electronically by the Payment Transport module 108 using the mode(s) preferred by each opted-in payee. In an exemplary aspect, upon notification, opted-in payees access the Payment Viewer 111 remotely through a PC web browser, mobile phone or tablet app, or similar function. Here, opted-in payees 110 can review the details of each received payment. In one aspect of the system, when the user selects a specific payment, the TMS invokes the Dynamic Rendering module 109. This renders in real-time an on-screen visual representation of a check and stub associated with the selected payment record. It is displayed side-by-side with tabular payment information within the Payment Viewer 111. With a dynamic connection to the TMS Payment Records DB 204, the opted-in payee may also access previously processed payment records. Opted-in payers 101 have similar access to payment records and can also access them utilizing the Payment Viewer 111 and Dynamic Rendering 109.

According the embodiment shown, the opted-in payee 110 may use functionality in the Payment Viewer 111 to engage the Payment Approval module 112 of the TMS. Using drop-down functionality in the Payment Viewer 111, the status of a payment may be updated. Such status changes include but are not limited to In Review, In Dispute, Approved, Deposited, Returned (such as for insufficient funds in the payer's account) and Paid (a final disposition once funds have cleared the payer's bank account). In one aspect of the system, as an opted-in payee 110 updates the status of a payment in the Payment Viewer 111, the Payment Approval module 112 dynamically updates the TMS Payment Records DB 204, and the new status is updated in real-time to the Payment Viewer screen 111 being viewed by the opted-in payer 101 of that specific payment record. It may be understood and appreciated that the real-time nature of the TMS can engender greater engagement and collaboration between opted-in payers and payees in managing payments and other aspects of their business relationships.

When the opted-in payee updates the payment status of a record to “Deposit”, the record is locked from further user updating by the TMS and the record is passed from Payment Approval 112 to the Deposit Transform module 113. In this module, the payment record is prepared for deposit by transforming the payment instructions into a file suitable for acceptance by either the Payee Bank's RDC or mobile RDC server 210. This process includes generating both front and rear images of a check based on the payment instructions. The Deposit Transform 113 accomplishes this by invoking the Dynamic Rendering module 109 that is also used in the Payment Viewer 111. In this instance, the visual representation of the check becomes a permanent representation for purposes of deposit. Additionally, certain data elements of the payment instructions are assembled in the specific data structure required for acceptance by the bank's RDC or mobile RDC functions. Once the images and required data elements are packaged in the appropriate file structure, the Deposit Transform module 113 sends the deposit file to the Payee Banks' RDC or mobile RDC server 210.

Upon receipt of the remote deposit, the Payee Bank's RDC server 210, through its API, confirms such receipt to the TMS Payment Approval module 112, which in turn updates the TMS Payment Records DB 204 and is reflected in the payment record status in the Payment Viewer 111. The Payee Bank 114 then presents the payment to the Payer Bank 212 for clearing and transfer of funds into the opted-in payee's bank account. Depending on its capabilities, the Payer Bank 212 may, through its API, be able to confirm receipt of forward presentment and clearing of funds to the Payee Bank to the payer accounting system 102, which may then update the payment status in the TMS Payment Records DB 204 through the accounting system API 102.

Still referring to the exemplary embodiment of the TMS 201 shown in FIG. 2, as the payment status changes in the Payment Viewer 111, the Payment Approval module 112, using the opted-in payee accounting system 211 API, may directly and automatically update records in the opted-in payee accounting system Account Receivable (AR) module 211. Such updates may include but are not limited to payment application to invoices (based on a TMS payment status of “approved”) and payment reconciling of invoices (based on a TMS payment status of “paid”). Concurrently, the AP module in the payer accounting system 102 may also be updated in similar fashion, as a payment status is dynamically updated in the TMS Payment Records DB 204 and flows back through the payer accounting system 102 API. This aspect can reduce manual effort and human errors in accounting processes and also provide common visibility and collaboration among opted-in payers and payees.

### Transaction Management System Architecture

Referring next to FIG. 3, an exemplary system architecture 300 for one embodiment of the disclosed transaction management system (TMS) 201 is shown. As shown, the architecture 300 includes within the TMS 201, the Check Run Mappings database (DB) 202, TMS Opt-In/Opt-Out DB 203, and TMS Payment Records DB 204, a plurality of main processing modules including the Print Processor 103, Payment Decisioning 104, Payment Transform 107, Payment Transport 108, Payment Approval 112, Deposit Transform 113, and Dynamic Rendering 109, and administrative functions 311. Additionally the system architecture includes connections to one or more financial institutions 114, 212 (including the Payee Bank's interface for RDC and mobile RDC transactions 210). The system architecture also includes connections to payer and payee accounting systems 102, 211 and payer-side OS print queue 105 and OS print driver 207. As will be understood, although the architecture represents systems of only one payer, payee, Payer Bank, and Payee Bank in the embodiment of FIG. 3, other embodiments include a plurality of both opted-in and opted-out users and financial institutions. Further, as will be appreciated, although only one database is shown each for the check run mappings, opt-in/opt-out data, payment records, payer and payee accounting systems, and Payer and Payee Banks, embodiments of the present TMS 201 utilize many databases to store system information as needed. Aspects of the internal hardware components associated with the TMS are shown and discussed in conjunction with FIG. 13.

According to a preferred embodiment, the TMS 201, financial institutions 114, 212 and payer and payee accounting systems 102, 211, and their respective components, communicate with each other via a conventional service-oriented architecture (SOA). Generally, a service-oriented architecture is an information technology infrastructure that allows different applications to exchange data with one another. Typically, a SOA separates functions into distinct units or services, which are made accessible over a network (such as the Internet), such that users of the system can combine and reuse them as desired. As will be understood, the communication protocol between the system components shown in FIG. 3 may vary depending upon each financial institution's and accounting system's preferred communication technique, and other similar file transfer mechanisms may be used according to embodiments in the present system.

In the embodiment shown in FIG. 3, the internal components (i.e., processor(s), memory(ies), etc.) of the TMS are operative in the main processing modules 103, 104, 107, 108, 112, 113, 109, and administrative functions 311 respectively (see FIG. 13 for more detailed representations). Also included as part of the TMS are TMS Opt-in/Opt-Out database 203, TMS Payment Records database 204, and Check Run Mappings database 202, respectively. The TMS Opt-in/Opt-Out database 203 includes the accounting system payers/payees table 312 containing information is extracted from and synchronized with users' accounting systems. This information is appended with TMS-system data stored in the appended TMS data payers/payees table 313 which includes but is not limited to each payer or payee's opt-in/opt-out status. In one embodiment, the information is used in decisioning payment records for electronic payment or paper check processing and also are part of the TMS payment instructions used by the Dynamic Rendering module in presenting check-image data to users and formatting payments for RDC or mobile RDC submission to the Payee Bank.

The TMS Payment Records database 204 includes the TMS payment instruction table 314 which stores payment instructions derived from opted-in payer check runs. This information is appended with TMS-system data stored in the TMS payment status table 315, which includes but is not limited to the current status and status history for each stored payment record. According to one embodiment, these records include payments intended for both opted-in 110 and opted-out payees 106 and also are part of the TMS payment instructions used by the Dynamic Rendering module 109 in generating visual check representations for users in the Payment Viewer 111 and permanent check representations formatted in payment files for RDC or mobile RDC submission to the Payee Bank Interface 210.

The Check Run Mappings database 202 stores pre-built mappings of commercial accounting systems' check run print layouts. Mappings are unique to each print layout in each accounting system in use by opted-in payers in order to separate payment information in each record of a print file from non-payment information. By way of illustration, payment information may include the payer name, address, phone number, bank routing number and bank account number, payee name, payee address, payment amount, and remittance information associated with a payment such as invoice numbers, amounts, et cetera. By way of illustration, non-payment information in a print record may include data and programming code that controls generation of the layout and graphic elements on a printed page, as well a the positioning of the payment data on the printed page. Mappings are used to disaggregate information in a check run print file so as to inspect print files as they enter a queue to determine whether they contain information indicative of a check run (i.e., payment information). In an embodiment, the same mapping is then used to extract said payment information for all payment records contained in a given check run print file for transformation and storage in the TMS Payment Records database 204.

Additionally, within the Payee and Payer Banks are at least one core system database, 301 and 303 respectively, for storing payee and payer payment transaction information. In one embodiment, the Payee Bank Core System DB 301 includes an account transaction table 302 for storing all check deposits received and recorded within the bank. Similarly, the Payer Bank Core System DB 303 includes an account transaction table 304 for storing all forward-presented checks received from Payee Banks for clearing and recorded within the bank.

Still referring to FIG. 3, within the payee and payer accounting systems are at least one system database, 305 and 308 respectively, for storing payee and payer account information and transaction information. In one embodiment, the Payer Accounting System DB 305 includes a payee account table 306 for storing information on all of the payer's payees, and a payment records table 307 for storing information regarding specific payments made or to be made to payees. Similarly, the Payee Accounting System DB 308 includes a payer account table 309 for storing information on all of the payee's payers, and an invoice records table 310 for storing information regarding specific invoices sent or to be sent to payers. As will be understood and appreciated by one of ordinary skill in the art, embodiments of the present TMS 201 are not limited to the specific tables mentioned in association with the databases 203, 204, 202, 301, 303, 305, 308, as other tables and data necessary for successful operation are included as well.

As will be understood and appreciated, the various components of aspects of the TMS 201 and each financial institution and opted-in payer or payee accounting system must share data in order to carry out their respective functions. Although data tables may be generated and stored within one system component, instances of data tables are transmitted to other system components as needed and cached locally for subsequent use.

### Onboarding Process

FIG. 4 is a flowchart of an embodiment of a computer-implemented user onboarding process 400 carried out by a particular machine (e.g. TMS 201) for enrolling users and setting up their preferences for sending and receiving payments through the TMS 201. The process also configures preferences for using the system's Print Processor 103 and Payment Transport 108 modules to cross-promote the TMS to the user's payers and payees.

For payers wishing to enroll in the TMS 201, the system provides a system-generated payer sign-up page 401 that interfaces to the payer accounting system using the payer accounting system API 402 to query the payer accounting system DB 305 for user company information such as but not limited to the official company name, billing address, bank account information (MICR line data), and both Accounts Payable and Accounts Receivable user information (user name, phone number, fax number, email address, etc.). The system populates the TMS sign-up page 401 with this company and user information, which the user then reviews, edits if necessary, and then accepts in order to begin the onboarding process. As will be understood by those skilled in the art, additional UI screens may be presented to the user including but not limited to providing additional information required for system operation, review and acceptance of the user license for accessing and using the various features of the TMS, and configuring user preferences and options of the system.

In one embodiment, upon completion of the aforementioned onboarding process, the system, through the payer accounting system API 402, queries the payee account table 306 (referenced in FIG. 3) in the payer accounting system DB 305. In this query, records of all of the opted-in payer's payees are extracted 404 and appended in the accounting system payers/payees table 312 (referenced in FIG. 3) in the TMS Opt-In/Opt-Out DB 203, which maintains records of all opted-in payers in the system and their payees. The opt-in/opt-out DB 203 includes additional data fields that control the treatment of each payee by the TMS. As part of the onboarding process, the newly opted-in payer is asked whether to allow the TMS to cross-promote the system to the opted-in payer's payees 406. If the opted-in payer selects “yes”, the system automatically generates electronic notifications (by email or other means) to the opted-in payer's payees. As will be understood, the notification messages are different for opted-in payees as well as those who subsequently opted-out or payees not yet opted-in to the TMS.

The notification sent to currently opted-in payees 407 announces the enrollment of the opted-in payer and asks each opted-in payee whether they wish to receive electronic payments from this opted-in payer. The notification provides a means for the opted-in payee to respond “yes” or “no”. This selection sets a flag in a data field in the appended TMS data payers/payees table 313 (referenced in FIG. 3) in the TMS Opt-In/Opt-Out DB 203 corresponding to the opted-in payee's choice whether to receive electronic payments from this specific opted-in payer. The system provides for the opted-in payee to modify this choice (start or stop receipt of electronic payments from this opted-in payer) at any future time.

The notification sent to opted-out payees 408 announces the enrollment of the opted-in payer and asks each opted-out payee whether they wish to enroll in the TMS 201 and receive electronic payments from this and/or other opted-in payers. The notification provides a means for the opted-out payee to respond “yes” or “no”. If the opted-out payee responds “no”, a flag is set in a data field in the appended TMS data payers/payees table 313 in the TMS Opt-In/Opt-Out DB 203 corresponding to that payee indicating that the payee is not enrolled (opted-out). If the payee responds “yes”, the payee is directed to the system-generated payee onboarding sign-up page to begin the payee enrollment process 409.

Continuing with FIG. 4, the payee onboarding process is similar to the payer onboarding process. The payee sign-up page 410 interfaces to the payee accounting system using the payee accounting system's API 415 to query the payee accounting system DB 308 for user company information such as but not limited to the official company name, remittance address, bank account information (MICR line data), and both Accounts Payable and Accounts Receivable user information (user name, phone number, fax number, email address, etc.). The system populates the TMS sign-up page 410 with this company and user information, which the user then reviews, edits if necessary, and then accepts in order to begin the onboarding process. Additional UI screens may be presented to the user including but not limited to providing additional information required for system operation, review and acceptance of the user license for accessing and using the various features of the TMS, and configuring user preferences and options of the system.

In an embodiment, upon completion of the aforementioned onboarding steps, the system, through the payee accounting system API 415, queries the payer account table 309 (referenced in FIG. 3) in the payee accounting system DB 308. In this process, records of all of the opted-in payee's payers are extracted 411 and appended in the accounting system payers/payees table 312 in the TMS Opt-In/Opt-Out DB 203, which maintains records of all opted-in payees enrolled in the system and their payers. The opt-in/opt-out DB 203 includes additional data fields that control the treatment of each payer by the TMS.

As part of the onboarding process, the newly opted-in payee is asked whether to receive electronic payments from all TMS opted-in payers or individually select opted-in payers from which to receive electronic payments 413. If the opted-in payee elects to receive payments from all opted-in payers 416, that flag is set in a data field in the appended TMS data payers/payees table 313 in the TMS Opt-In/Opt-Out DB 203. If the opted-in payee elects to individually select opted-in payers, they are presented with a UI listing all opted-in payers corresponding to their payer account table 309 in the payee accounting system DB 308 along with a method for selecting whether to receive electronic payments from each opted-in payer 417. These selections are updated in the TMS data payers/payees table 313 in the TMS Opt-In/Opt-Out DB 203. The TMS provides for the opted-in payee to modify this choice (start or stop electronic payments) at any future time.

Additionally as part of the onboarding process, the opted-in payee is asked whether to allow the TMS 201 to cross-promote the system to the opted-in payee's opted-out (un-enrolled) payers 414. If the opted-in payee selects “yes”, the system automatically generates electronic notifications (by email or other means) to the opted-in payee's opted-out payers 418. The notification announces the enrollment of the opted-in payee and asks each opted-out payer whether they wish to enroll in the system and send electronic payments to opted-in payees. The notification provides a means for the payer to respond “yes” or “no”. If the payer responds “no”, a flag is set in a data field in the appended TMS data payers/payees table 313 in the TMS Opt-In/Opt-Out DB 203 corresponding to that payer indicating that the payer remains opted-out. If the payer responds “yes”, the payer is then presented with the system-generated payer sign-up page 401 to begin the payer enrollment process.

### Maintenance Process

Referring now to FIG. 5, a flowchart of an embodiment of a computer-implemented user maintenance process 500 carried out by a particular machine (e.g. TMS 201) for maintaining opt-in and opt-out payers and payees. As described above as part of the onboarding process, the TMS 201, through the accounting system API, queries the opted-in payer's payee account table 306 (referenced in FIG. 3) and in this process, all data pertaining to the opted-in payer's payees are extracted and appended to the TMS Opt-In/Opt-Out DB 203, which maintains records of all of the payees of all companies that are enrolled in the system.

From time to time, the opted-in payer will update records in the payer accounting system AP module 102 (referenced in FIG. 3) regarding information about payees. This updating process is accomplished in the Accounting System Payer Maintenance Screens 501 in the payer accounting system. This information includes but is not limited to the accounting system unique identifier for each payee, the payee company name, mailing address, AR contact name, phone number, and email address. Modifying this information updates the payee account table 306 in the payer accounting system DB 305. It will be understood and appreciated by one skilled in the art that through the accounting system API, these records may be synchronized and automatically updated in the TMS Opt-In/Opt-Out DB 203.

From time to time, the opted-in payee will update records in the payee accounting system AR module 211 (referenced in FIG. 3) regarding information about payers. This updating process is accomplished in the Accounting System Payee Maintenance Screens 503 in the payee accounting system. This information includes but is not limited to the accounting system unique identifier for each payer, the payer company name, mailing address, AP contact name, phone number, and email address. Modifying this information updates the payer account table 309 in the payee accounting system DB 308. It will be understood and appreciated by one skilled in the art that through the accounting system API, these records may be synchronized and automatically updated in the TMS Opt-In/Opt-Out DB 203.

From time to time, the opted-in payers and payees will update data fields in the TMS Opt-In/Opt-Out DB 203, based on changes in preferences. Opted-in payers and payees accomplish this updating process using the TMS User Maintenance Screens 504. Updated information includes but is not limited to whether a specific opted-in payer's payee or specific opted-in payee's payer continues to be opted-in to the TMS, whether an opted-in payee accepts electronic payments from a specific opted-in payer or vice-versa, and whether an opted-in payer or payee permits cross-promotion of the TMS to other trading partners.

The TMS 201 includes extensive data fields in the opt-in/opt-out DB 203 that control the treatment of each payer and payee by the TMS, including but not limited to the accounting system payers/payees table 312 (referenced in FIG. 3) and the appended TMS data payers/payees table 313 (not shown). These fields are set initially for each payer and payee during the onboarding process. In an exemplary aspect, the User Information Database View 502 shows a merged view the data fields available in the TMS Opt-In/Opt-Out DB 203 that may be modified and maintained through either Accounting System Payer Maintenance Screens 501, Accounting System Payee Maintenance Screens 503, or TMS User Maintenance Screens 504.

As will be understood be one having ordinary skill in the art, the User Information Database View 502 is presented for illustrative purposes only, and embodiments of the present system 201 are not limited to the specific data table shown. Similarly, it will be understood that the data categories or fields are not limited to the fields shown, and other embodiments include additional fields as will occur to one of ordinary skill in the art. As will also be understood, although only nine data entries are shown in the User Information Database View 502 and sixteen data fields, actual data tables constructed in accordance with aspects of the present system may include a virtually unlimited number of entries corresponding to a plurality of payment records processed by embodiments of the present TMS 201.

### Payment Generation Process

Referring now to FIG. 6A, a flowchart is shown illustrating a payment generation process 600 from the perspective of an opted-in payer 101 according to an embodiment of the present transaction management system 201. Such steps are generally computer-implemented, and tied to the operations of a particular machine (TMS 201), but herein described from the perspective of the opted-in payer to enable a person skilled in the art of computer programming to construct a suitable computer implemented method and system for a user interface. Generally, a payment is generated to satisfy a plurality of invoices which can be delivered to one payee.

As shown in FIG. 6A, at step 601, an opted-in payer 101 logs into their associated payer accounting system and, using standard Accounts Payable functionality inherent in the accounts payable module 102, the opted-in payer determines which invoices received from payees shall be paid through the process of approving individual invoices for payment. The accounting system then prepares payment records for paying several invoices to several payees.

The opted-in payer then initiates a check run print job within the accounting system 602, which prepares a print file containing information about each payment including but not limited to the payee company and accounts receivable user information, the payment amount, and the remittance details (invoice number, description of invoice, and invoice amount). Under typical conditions, this print file is then sent to an operating system (OS) print queue 603, which then controls the release of print jobs for printing of checks and stubs (remittance information) on the payer's printer.

In one embodiment of the TMS 201, the print queue is monitored 604 by the Print Processor 103, which uses pre-built mappings of commercial accounting systems' check run print layouts to inspect print files as they enter a queue, and determine whether it is a check run. These mappings are stored in the Check Run Mappings DB 202. Non-check run print files are allowed to pass to an associated OS print driver for normal printing. However, check runs are extracted from the print queue 605, and forwarded to the Payment Decisioning module of the TMS 104 for processing 606.

Upon receipt of this print file, the Payment Decisioning module 104 inspects each record in the print file to determine whether the payee is to receive a printed check and stub as payment or an electronic payment. Those skilled in the art will understand and appreciate that the decisioning process now described applies to every record in the print file in a looping fashion until all records have been processed. In this decisioning process, the system inspects two data fields in the TMS Opt-In/Opt-Out database (DB) 203. These two fields are the Opted-In To TMS field and the Opted-In To This Payer field. If either of these fields is flagged “no” (not an opted-in payee, not opted-in to receive electronic payments from this opted-in payer, or both), then the record in the print file is marked for paper check payment. If both of these fields are flagged “yes” (opted-in payee and opted-in to receive electronic payments from this opted-in payer) then the record is marked for electronic payment 607.

In another embodiment, “No” records are extracted and rebundled into a new check run print file 608, and sent to a new print queue 609. The new print file, containing only payment records intended for opted-out payees, now proceeds in the traditional fashion: it is then sent to appropriate OS print driver 610, where it is directed to the printer for printing checks and stubs 611. The payer then mails the checks and stubs to opted-out payees 612.

Referring now to FIG. 6B, a flowchart illustrating an alternative embodiment of the decisioning method in the payment generation process in FIG. 6A is shown. At step 601, an opted-in payer 101 logs into the payer accounting system and, using standard Accounts Payable functionality inherent in the accounts payable module 102, the opted-in payer determines which invoices received from payees shall be paid through the process of approving individual invoices for payment. The accounting system then prepares payment records for paying several invoices to several payees.

The opted-in payer then initiates a check run print job within the accounting system 602, which prepares a print file containing information about each payment including but not limited to the payee company and accounts receivable user information, the payment amount, and the remittance details (invoice number, description of invoice, and invoice amount). Under typical conditions, this print file is then sent to an operating system (OS) print queue 603, which then controls the release of print jobs for printing of checks and stubs (remittance information) on the payer's printer.

In one embodiment of the TMS 201, the print queue is monitored 604 by the Print Processor 103, which uses pre-built mappings of commercial accounting systems' check run print layouts to inspect print files as they enter a queue, and determine whether it is a check run. These mappings are stored in the Check Run Mappings DB 202. Non-check run print files are allowed to pass to an associated OS print driver for normal printing. However, check runs are extracted from the print queue. One copy of the check run print file is buffered (stored temporarily in system memory) in unaltered form 613, and another copy is sent to the Payment Decisioning Module 104 for processing 614.

Upon receipt of this print file, the Payment Decisioning module 104 inspects each record in the print file to determine whether the payee is to receive a printed check and stub as payment or an electronic payment. Those skilled in the art will understand and appreciate that the decisioning process now described applies to every record in the print file in a looping fashion until all records have been processed. In this decisioning process, the system inspects two data fields in the TMS Opt-In/Opt-Out database (DB) 203. These two fields are the Opted-In To TMS field and the Opted-In To This Payer field. If either of these fields is flagged “no” (not an opted-in payee, not opted-in to receive electronic payments from this opted-in payer, or both), then the record in the print file is marked for paper check payment. If both of these fields are flagged “yes” (opted-in payee and opted-in to receive electronic payments from this opted-in payer) then the record is marked for electronic payment 615.

In another embodiment, the decisioned print file records are now matched against the unaltered records in the buffered print file 613. This matching process 616, is used to extract print file records for opted-in payees from the buffered print file. The remaining records are then rebundled into a new print file containing only the records for opted-out payees 617, and sent to a new print queue 609. The new print file, containing only payment records intended for opted-out payees, now proceeds in the traditional fashion: it is then sent to appropriate OS print driver 610, where it is directed to the printer for printing checks and stubs 611. The payer then mails the checks and stubs to opted-out payees 612.

Following now from connector A 620 on both FIG. 6A and FIG. 6B to connector A 620 on FIG. 6C, embodiments of the TMS 201 are used to transform all payment records from the original check run print file for storage in the TMS Payment Records DB 204. It will be understood and appreciated that even for payments that are printed and mailed to opted-out payees, storing them in a common repository and format and through the use of APIs available from both Payer and Payee Banks and accounting systems, payments may be automatically applied and reconciled in users' accounting systems and there status updated in the TMS Payment Records DB 204. Further, storing both opted-in and opted-out payment records enables users to view such payments and automated changes in status in the same method, that is, in the Payment Viewer 111.

In FIG. 2, using the appropriate mapping from the check run mappings DB 202, print file payment records are disaggregated into their basic data elements 621. The Payment Transform module 107 then restructures those elements 622 to conform to the data format of the TMS Payment Records DB 204 and stores those records therein 623. Once stored in the TMS Payment Records DB, payment records can be viewed and manipulated in the Payment Viewer 111 by both opted-in payers and payees associated with a given record.

Following this step, a subset of data elements from the check run records intended for opted-in payees and now stored in the TMS Payment Records DB 204, are extracted 624 from the payment records DB and formatted into individual payment record notices for transport to each respective opted-in payee 625. Each payment record notice is parsed, hashed and encrypted using current best practices to ensure secure control over the data 626. At the completion of this step, the notices are ready for transport to individual opted-in payees.

Referring next to FIG. 6D, an illustration is provided in 600 showing a screen capture of an exemplary email notice 630 as transported to the designated opted-in payee by the Payment Transport module 108, according to one embodiment of the TMS 201 constructed and operated in accordance with various aspects of the claimed invention(s). As will be described in an embodiment in FIG. 10, at the conclusion of the payment generation processing, and for each opted-in payee for which a new payment record was generated, an electronic notice is generated and sent to the opted-in payee. As will be understood and appreciated, the example email notice 630 represents merely one approach or embodiment of the present system, and other aspects are used according to various embodiments of the present system.

In such a related aspect, notification may be conducted by one or more electronic means based on the preferences of the opted-in payee. These means include but are not limited to email, SMS text message, Skype message, applet running on a personal computer, or app running on a mobile device. In a related aspect, notifications are sent in real time as each payment notice is generated. The system provides for these notices to be stored as received. As will be understood be one having ordinary skill in the art, the exemplary email notice 601 is presented for illustrative purposes only, and embodiments of the present system 201 are not limited to the specific method shown.

### Exemplary Transaction Records

FIG. 7 is an illustration provided in 700 showing a screen capture of an exemplary transaction records as illustrated in a payment records database table 701 illustrating data associated with payment records stored in the TMS Payment Records DB 204 generated during the payment generation process 600. In the embodiment shown, in addition to data elements extracted from the original check run print file (such as the bank route number and payer checking account number), certain data fields contain information specific to the TMS Payment Approval 112 and Deposit Transform 113 processes including whether the payment is for an opted-in or opted-out payee (field name “IsKokopay”, set to “True” or “False” respectively), and the current status of the payment based on opted-in payees' use of the Payment Approval module (field name “CheckStatusId”, set to 1=Open, 2=In Review, 3=In Dispute, 8=Deposited).

As will be understood be one having ordinary skill in the art, table 701 is presented for illustrative purposes only, and embodiments of the present system 201 are not limited to the specific data table shown. Similarly, it will be understood that the data categories or fields are not limited to the fields shown, and other embodiments include additional fields as will occur to one of ordinary skill in the art. As will also be understood, although only twenty data entries are shown in table 701 and eleven data fields, actual data tables constructed in accordance with aspects of the present system may include a virtually unlimited number of entries corresponding to a plurality of payment records processed by embodiments of the present TMS 201.

### Exemplary Payment Viewer

Referring next to FIG. 8, an illustration is provided in 800 showing a screen capture of exemplary Payment Viewer 111 data according to one embodiment of the TMS 201 constructed and operated in accordance with various aspects of the claimed invention(s). As will be understood and appreciated, the example Payment Viewer 111 as accessed by the opted-in payee 110 in this illustration, represents merely one approach or embodiment of the present system, and other aspects are used according to various embodiments of the present system. As expressed in the discussion of FIG. 6C, once stored in the TMS Payment Records DB 204, payment records can be viewed and manipulated in the Payment Viewer 111 by both opted-in payers and payees associated with a given record.

One skilled in the art will appreciate that through the headings row on the tabular display 801, information may be filtered, reordered, or otherwise manipulated to present a view of the information best suited to the user's then-current needs. In another aspect of the system, the Payment Viewer's tabular display provides a drop-down selection function that invokes the Payment Approval module 112, which allows the opted-in payee to process payments automatically by changing the status of a payment record. In one embodiment, this function is activated by pressing the “UPDATE” button visible in the tabular display. The opted-in payee 110 may approve or reject a payment, or leave it open pending further review.

In one aspect of the system, when the user selects a specific payment in the tabular display 801, the TMS 201 invokes the Dynamic Rendering module 109, which renders in real-time the payment instruction data into a visual check-and-stub representation 802, side-by-side the tabular display within the Payment Viewer 111. The user may “toggle” the view of the front and back of the check. Additionally the Dynamic Rendering module also renders the remittance information or “stub” (invoice number, description of the invoice, invoice amount due) contained in the payment instructions to complete the visual representation. This virtual analog of a check and stub allows opted in payers 101 and opted-in payees 110 to review the payment details in a form that they are most accustomed, thus easing the transition from a paper-based payment process to an electronic one.

### Dynamic Rendering Process in Payment Viewer

Referring now to FIG. 9, a flowchart is shown illustrating a dynamic rendering process 900 performed by the Dynamic Rendering module 109 from the perspective of an opted-in payer 101 or opted-in payee 110 according to an embodiment of the present transaction management system 201. Such steps are generally computer-implemented, and tied to the operations of a particular machine (TMS 201), but herein described to enable a person skilled in the art of computer programming to construct a suitable computer implemented user interface.

In one embodiment, a user reviewing payment records in the Payment Viewer 111, selects a record in the tabular display 801 by clicking on the record row with a mouse or similar pointing device 901. This causes the TMS 201 to invoke 902 the Dynamic Rendering module 109. The Dynamic Rendering module conducts a data lookup 903 based on the payment record selected by the user. In this step, the Dynamic Rendering module retrieves variable payment information for the selected payment record from the TMS Payment Records DB 204. This information includes but is not limited to the payee name, check number, issuance date, payment amount, and memo information. Additionally, it includes the remittance information including but not limited to the invoice numbers to be paid along with each associated invoice date, GL code, remittance description, and invoice amount. Also, the Dynamic Rendering module retrieves static payment information for the selected record from the TMS opt-in/opt-out DB 203. This information includes but is not limited to the payer name and address, and routing and account numbers on which the check is to be drawn.

Continuing on FIG. 9, the Dynamic Rendering module 109 assembles the retrieved information and generates three images as follows: The check front, check back, and payment stub 904. In the initial visual check-and-stub representation 802, the Dynamic Rendering module assembles the check front and stub images overlaid onto a check and stub background, and in the Payment Viewer 111, displays a compete check and stub representation 905.

In a related aspect, by clicking on the check image itself 906, the user may “toggle” the representation to show the front check image, rear check image, and back again 907. The user may, at any time, select another record in the tabular display 901 in the Payment Viewer 111, which invokes the Dynamic Rendering module 109 to begin the process again 902.

As will be understood be one having ordinary skill in the art, the workflow presented is one embodiment only and embodiments of the present system 201 are not limited to the specific description herein. Similarly, it will be understood that the data categories or fields are not limited to the categories described, and other embodiments include additional categories and fields as will occur to one of ordinary skill in the art.

### Payment Approval Process

Referring now to FIG. 10, a flowchart is shown illustrating a Payment Approval process 1000 from the perspective of an opted-in payee 110 according to an embodiment of the present transaction management system 201. Such steps are generally computer-implemented, and tied to the operations of a particular machine (TMS 201), but herein described from the perspective of the opted-in payee to enable a person skilled in the art of computer programming to construct a suitable computer implemented user interface. In one embodiment, the payment record notices related to payments for opted-in payees having been prepared in 600, are now delivered individually to opted-in payees by the Payment Transport module 108 using a secure process 1001, for review, disposition, and eventual deposit as part of the TMS 201.

Generally, a payment is received as a single payment intended to satisfy a plurality of invoices. In an exemplary aspect of the system, opted-in payees are notified based on the preferences of the opted-in payee 1002. The TMS configuration options for notification include the timing of notice deliveries (including but not limited to “immediately”, “hourly”, “daily”, “weekly”, “never”) and the means of delivery. Such means include but are not limited to email, SMS text message, Skype message, applet running on a personal computer, or app running on a mobile device. Upon receiving one or more payment record notices, the opted-in payee may access and review the payment instructions for each payment by launching the Payment Viewer 111. In an exemplary aspect of the system, the Payment Viewer may be launched from the user's preferred electronic notice method (for example, a link in an email to a TMS web browser application, or a function within a TMS mobile phone app) or directly (for example, launching the functionality by opening a web browser session, then navigating to a TMS website and logging in) 1003.

In one embodiment, the Payment Viewer 111 provides the opted-in payee with a GUI that presents a tabular display of payment records as illustrated in FIG. 8. The opted-in payee may optionally change the record filtering to view any combination of their open, approved, rejected, applied, or reconciled payments. Also, the tabular display may be configured to alter the level of detail presented to the user, or change the date range to increase or reduce the number of records viewed.

As described in FIG. 9, within the Payment Viewer 111, when the user selects a specific payment in the tabular display 801, the TMS 201 invokes the Dynamic Rendering module 109 that dynamically renders the payment instruction data into a visual check representation on the user's display. The user may “toggle” to view the front or back of the check. Additionally the Dynamic Rendering module also renders the remittance information (including but not limited to the invoice number, description of the invoice, invoice amount due) specific to the payment selected for viewing. This creates a complete visual representation of a paper check payment including the check and stub 802 within the Payment Viewer GUI. This virtual analog of a check and stub allows the opted-in payee to review the payment details in a form to which they are most accustomed, thus easing the transition from a paper-based accounts receivable process to an electronic one.

The tabular display in the GUI 801 also provides a drop-down selection function that invokes the Payment Approval module 112, which allows the opted-in payee to process payments automatically by changing the status of a payment record 1004. In one embodiment, this function is activated by pressing the “UPDATE” button visible in the tabular display. In this fashion, the opted-in payee 110 may select from any number of status change options, including but not limited to approving or rejecting a payment, marking it in dispute, or leaving it open pending further review. As the status is changed, the change is dynamically updated in the TMS Payment Records DB 204. As will be understood be one having ordinary skill in the art, the drop-down function is presented for illustrative purposes only, and embodiments of the present system 201 are not limited to the specific status changes described. Using essentially similar TMS Payment Viewer functionality 111, opted-in payers 101 may also review the status of payments they have generated to opted-in payees.

Once an opted-in payee has determined whether to approve certain payments, the opted-in payee can elect to apply payment amounts to specific invoices and/or process said payments for deposit. In another aspect of the system, the opted-in payee may configure the TMS 201 to automatically apply payment against the open invoices (remittance details) associated with each payment in the AR module of the payee accounting system 211, using the accounting system API 1005.

### Exemplary Payment Transaction

Referring next to FIGS. 11A, 11B, and 11C, an illustration is provided in 1100 showing screen captures of an exemplary payment transaction from the perspective of either an opted-in payer or payee using the Payment Viewer 111 and including the payment records associated with each screen capture. As will be understood and appreciated, the example payment transaction represents merely one approach or embodiment of the present system, and other aspects are used according to various embodiments of the present system.

As expressed in the discussion of FIG. 10, a drop-down function in the Payment Viewer 111 allows the opted-in payee 110 to process payments automatically by changing the status of a payment record 1004. In this exemplary illustration, the opted-in payee reviews a payment upon initial notification from an opted-in payer 101, changes the status to In Dispute, and then initiates deposit with the payment status changing to “Deposited”.

Returning now to FIG. 11A, the focus of this illustration is on Check #10017 in the amount of $695.12. The initial payment status is “Open”. This status is reflected in both the opted-in payer's Payment Viewer GUI (top) 111 and opted-in payee's Payment Viewer GUI (bottom) 111. Additionally, exemplary screen capture displays information regarding each payment in the Payment Records Database Table 701A, which is a data view derived from data stored in the TMS Payment Instruction Table 314 and the TMS Payment Status Table 315 within the TMS Payment Records DB 204. Referring again to the Payment Records Database Table 701A, the CheckStatusld field, which stores the current status of each payment record, is set to “1”, indicating that the payment status is “Open”.

In FIG. 11B, the opted-in payee 110 uses the drop-down function in the Payment Viewer to change the status from “Open” to “In Dispute” (bottom) 111. This change in status is reflected in the exemplary screen capture of the Payment Records Database Table 701B, CheckStatusld field, which stores the current status of each payment record, now set to “3”, indicating that the payment status is now “In Dispute”. This status change is propagated in real-time to the opted-in payer's Payment Viewer GUI (top) 111 as well.

In FIG. 11C, the opted-in payee uses the drop-down function in the Payment Viewer to change the status from “In Dispute” to “Deposited” (bottom) 111. This change in status is reflected in the exemplary screen capture of the Payment Records Database Table 701C, CheckStatusld field, which stores the current status of each payment record, now set to “8”, indicating that the payment status is now “Deposited”. This status change is propagated in real-time to the opted-in payer's Payment Viewer GUI (top) 111 as well. One skilled in the art will understand and appreciate the value of real-time information presented to users. Not only does this allow opted-in payers to better plan payments and cash flow, it also enables opted-in payers and payees to collaborate more effectively on resolving disputes and negotiating the timing of payments.

### Deposit Transform Process

Referring next to FIG. 12, a flowchart is shown illustrating a deposit transform process 1200 from the perspective of an opted-in payee 110 according to an embodiment of the present transaction management system 201. The deposit transform process prepares electronic payments for remote deposit, conducts said deposits through a Payee Bank Interface 210 and into a Payee Bank 114 and reconciles payment with the TMS Payment Records DB 204, and payer and payee accounting systems 102, 211. Such steps are generally computer-implemented, and tied to the operations of a particular machine (TMS 201), but herein described from the perspective of the opted-in payee to enable a person skilled in the art of computer programming to construct a suitable computer implemented user interface.

In one embodiment, a payment record is updated by the opted-in payee 110 using the drop-down functionality of the Payment Viewer 111 to change the payment status for depositing the payment electronically in the Payee Bank 114. The selected payment must be transformed from the TMS Payment Records DB 204 data structure to the data structure required by the Payee Bank 114 to facilitate an RDC or mobile RDC deposit transaction 210. Changing the payment record status in the Payment Viewer invokes the Deposit Transform module 113, which initiates this deposit transform process 1201.

The Deposit Transform module invokes the Dynamic Rendering module 109 which accesses payment instructions of the target record as described in 900. For the deposit transform process, only the front and rear check images are rendered 1202. These images will become permanent representations of the front/back check images as part of the RDC deposit file. Sequentially, the information required by the Payee Bank 114 for the payment is populated in the bank-specified data structure 1203. The front and rear check images and populated data structure are packaged into the final payment record for deposit and stored 1204, pending delivery to the Payee Bank interface 210 by the TMS 201. As will be understood, although only one opted-in payee, payment, Payer Bank, and Payee Bank are referenced in the present embodiment, other embodiments include a plurality of users, payments, and financial institutions. As will also be understood, a system constructed in accordance with aspects of the present system may include a virtually unlimited number of payment transforms corresponding to a plurality of payment records processed by embodiments of the present TMS 201.

Returning now to the discussion of the present embodiment, once all target payment records have been transformed from the TMS Payment Records DB 204 structure to the Payee Bank 114 RDC deposit structure, the transformed records are electronically transported to the Payee Bank RDC/mobile RDC interface 210 for deposit 1205, using the means of transport required by the Payee Bank. Upon acceptance of the payments by the bank's RDC or mobile RDC interface, the payment is deposited into the opted-in payee's account 1206. It will be understood and appreciated by those skilled in the art, that this is one possible embodiment, and that the electronic transportation of transformed payment records may be executed singularly or in a plurality, Further, the payment records may be transported immediately, ad hoc, based on a processing schedule agreed to by the opted-in payee, Payee Bank, payment processing intermediary, other parties to the deposit process, or based on some other criteria.

In an alternative embodiment (not shown), the transformed records are electronically transported to the RDC/mobile RDC interface of a payment processing intermediary. In this embodiment, the payment processing intermediary acts as a processing aggregator and forwards the transformed records to the Payee Bank for deposit in the opted-in payees' accounts. Alternatively, in the deposit transform process, the payments embodied in the payment records may be endorsed to the payment processing intermediary for deposit in a holding account. In this mode, upon receipt of RDC/mobile RDC deposits, the payment processing intermediary forward presents the payments to the designated Payer Banks on which the funds are drawn. Upon clearing of the funds, the payment processing intermediary transmits the funds to the respective Payee Banks for deposit in the opted-in payees' accounts using one or more means including ACH, electronic funds transfer, or as a printed and mailed check.

In another alternative embodiment (not shown), the transformed records are electronically transported to the RDC/mobile RDC interface of a payment processing intermediary. In this embodiment, the payment processing intermediary acts as a processing aggregator on behalf of the Payee Bank and either prints and couriers the checks to each designated Payer Bank for forward presentment or, in an alternative mode, prints the checks at a location designated by each Payer Bank for immediate forward presentment.

Returning now to FIG. 12, using its API, the Payee Bank RDC/mobile RDC interface 210 then sends a deposit acceptance notification 1207 to the TMS 201. The notification is processed by the Payment Approval module 112 which updates the status of the payment in the TMS Payment Records DB 204. In a related aspect, the opted-in payee 110 may configure the TMS 201 such that once the deposit acceptance notification is received and updated in the TMS Payment Records DB 204, the TMS will automatically reconcile and close the open invoices (remittance details) associated with the deposit in the Payee Accounting System (Accounts Receivable Module) 211, using the Payee Accounting System API 415 (as shown in step 1209).

Following deposit acceptance notification 1207, the Payee Bank 114 electronically presents the payment to the Payer Bank 212 for clearing 1210, as per standard bank clearing agreements and processes. The Payer Bank clears the payment (sends funds to the Payee Bank) and posts the transaction details the opted-in payer's 101 account 1211. Depending on its capabilities, the Payer Bank 212 may, through its API, be able to confirm receipt of forward presentment and clearing of funds to the Payer Accounting System (Payable Module) 102. Otherwise the opted-in payer will reconcile the transaction manually by accessing the standard user functionality in the Payer Accounting System (Payable Module). In either instance, once the payment has been reconciled, the Payer Accounting System (Payable Module) may then update the payment status in the TMS Payment Records DB 204 through the accounting system API 402 (as shown in step 1212).

### Exemplary Transaction Management System Hardware

FIG. 13 illustrates an exemplary TMS hardware architecture 1300 upon which an embodiment of the TMS may be implemented as herein described. As shown in FIG. 13 and described previously herein, the hardware components of the TMS 201 are specifically designed to carry out the particular functions and processes of the TMS (i.e., they are particular machines). As will be understood and appreciated, the hardware representation 1300 is shown for illustrative purposes only, and other hardware variations will occur to those of ordinary skill in the art. Further, the hardware implementation shown in FIG. 13 does not necessarily include representations of detailed hardware connections via firewalls, reverse proxies, or other system components that may or may not be needed for the implementation of the TMS.

As shown, the TMS includes a bus 1301 or other communication mechanism for communicating information, and one or more processors 1305, coupled with the bus for processing information. The TMS also includes main memory such as system read-only memory (ROM) 1302 and system random-access memory (RAM) 1303 or other similar dynamic storage device, coupled with the bus for storing instructions and information to be executed by the processor 1305. In addition, system RAM 1303 may be used for storing temporary variables or other intermediate information during execution of instructions to be executed by the processor(s). As shown, the TMS includes read-only memory (ROM) 1302 or other similar static storage device coupled with the bus for storing static information and instructions for the processor(s). Also within the TMS are the TMS databases 1304, which include but are not limited to the Check Run Mappings DB 202, TMS opt-in/opt-out DB 203, and the TMS payment records DB 204. These are coupled with their respective buses and used for storage and retrieval of various types of system data as previously described, in one embodiment, the TMS databases reside separate and apart from any web server, such that the TMS databases reside behind one or more firewalls.

The TMS hardware system 1300 includes a communication interface 1306, coupled with the communication bus 1301, which provide a two-way communication coupling to a network link 1307. The communication interface generally comprises an Ethernet or similar network interface card or controller, a digital subscriber line (DSL), or other similar interface. The network link may comprise a wireless link, hard-wired link, or similar link. Additionally, for ease of reference, firewall(s), reverse proxies, and other ancillary components are not shown in FIG. 13, but it will be understood that these components comprise a part of the overall hardware architecture of embodiments of the present system.

For the embodiment of the TMS 201 shown in FIG. 13, the network link 1307 provides data communication from the local network via the Internet 1308 to a web browser 1309, providing users with access to the TMS 201, using the system's graphical user interface. Thus, all information transmitted to and from the TMS, both to and from opted-in payers and payees 101, 110, their accounting systems 102, 211, and any respective payee bank interfaces 210, is transmitted via the communication link 1307. Again, the hardware components and connections illustrated in FIG. 13 are presented for illustrative purposes only, and other system configurations are possible according to various embodiments of the present inventions.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A computer-implemented method for providing a payment to a selected payee on behalf of a payer, the payer utilizing an accounting system that stores payments data corresponding to one or more payments to be made by the payer for electronic delivery to one or more payees, comprising the steps of:
maintaining in a network-accessible transaction management system (TMS) computer, a data file of payees associated with the payer, the data file of payees comprising payee identifying information and electronic payment opt-in status indicating assent by payees of receipt of electronic payments;
receiving, at the TMS computer, payments data from a payer's accounting system including information corresponding to at least one pending payment to be made by the payer to at least one identified payee;
processing, at the TMS computer, the payments data to extract payee identification information and payment detail information;
accessing, at the TMS computer, the data file of payees, to determine if extracted payee identification information for a pending payment corresponds to an existing payee in the data file and if so, to determine the opt-in status of the existing payee;
in response to a determination that extracted payee identification information for the pending payment corresponds to an existing payee in the data file that possesses an opt-in status, generating, at the TMS computer, an electronic payment instruction;
in response to accessing of the TMS computer by the payee for the pending payment, displaying data corresponding to the electronic payment instruction to the payee;
receiving, at the TMS computer, a payment status command input by the payee in response to viewing the displayed electronic payment instruction, the payment status command comprising the selection by the payee of a predetermined payment status chosen by the payee for the pending payment; and
in response to selection by the payee of a payment status corresponding to approval of receipt of the payment, at the TMS computer system, transmitting the electronic payment instruction to a payment recipient system for processing by the payment recipient system on behalf of the payee.

2. The method of claim 1, further comprising the steps of generating a new opt-out print file containing information corresponding to pending payments to be made by the payer to identified payees that correspond to an existing payee in the data file that possesses an opt-out status, and communicating the new opt-out print file to a printer for printing of paper checks.

3. The method of claim 1, wherein the step of displaying the electronic payment instruction to the payee is in response to selection of information relating to payment by a payee on a display of received payments.

4. The method of claim 1, wherein the payments data from the accounting system is an electronic print file.

5. The method of claim 1, wherein the electronic payment instruction comprises an electronic check representation corresponding to the payment detail information associated with the pending payment.

6. The method of claim 1, wherein the electronic payment instruction is provided to the payment recipient system as an electronic check.

7. The method of claim 1, wherein the method comprises providing a payment to the selected payee on behalf of the payer, and providing an integrated payment status management system on behalf of payers and payees that allows payees to electronically indicate a status with respect to a payment from a payer and that allows payers to electronically view status indicated by payees with respect to payments made by payers.

8. The method of claim 7, wherein the integrated payment status management system displays electronic check representations for viewing by payees, receives payment status indications by payees, and displays electronic check representations of viewing by payers, and displays payment status indications made by payees to payers.

9. The method of claim 1, wherein the transaction management system (TMS) computer is independent of the payer's accounting system, and is electronically coupled to the accounting system to electronically receive the payments data from the payer's accounting system.

10. The method of claim 1, further comprising the step of maintaining, in the TMS computer, a payment records database comprising information corresponding to payments from payers to payees utilizing the TMS computer.

11. The method of claim 10, wherein the payment records database stores information corresponding to opted-in as well as opted-out payments.

12. The method of claim 1, further comprising the step of maintaining, at the TMS computer, a check run mapping database storing information that allows parsing of the payments data from a particular payer's accounting system to extract predetermined information corresponding to pending payments from the payer.

13. The method of claim 12, wherein the predetermined information corresponding to pending payments from the payer comprises information including but not limited to: payee identification information, payee name, data, payment amount, bank routing number, payer bank account number, and payment remittance information.

14. The method of claim 12, wherein the step of processing the payments data at the TMS computer system includes accessing the check run mapping database to obtain mapping information for extracting payee identification information.

15. The method of claim 1, further comprising the steps of, in response to a determination that extracted payee information in the payments data corresponds to a payee that has not indicated opt-in status or is not in the data file of payees,
generating an electronic print file including payment information for payees that do not possess opt-in status and omitting payees that possess opt-in status, and
communicating the electronic print file to a system for printing paper checks.

16. The method of claim 1, wherein the data corresponding to the electronic payment instruction comprises an electronic image of a check including but not limited to primary check information corresponding to a payee field, a data, an amount, a check number, a bank routing number, and a payer account number.

17. The method of claim 1, further comprising the step of, generating, at the TMS computer, an electronic check representation for access by the payer and by the payee identified for the pending payment in response to a predetermined user action.

18. The method of claim 17, wherein the predetermined user action comprises selection by the payer or by the payee of information on a display screen corresponding to the pending payment.

19. The method of claim 17, wherein the electronic check representation is viewed by a payer or payee in response to selection by the payer or payee using a graphical user interface associated with the TMS computer.

20. The method of claim 17, wherein the electronic check representation includes, in addition to primary check information, remittance information corresponding to one or more invoices associated with the payee indicated by the payer for payment with the pending payment.

21. The method of claim 1, further comprising the step of storing information at the TMS computer corresponding to the pending payment in a payment records database for viewing and status indication by the payee and for viewing by the payer.

22. The method of claim 1, further comprising the step of providing, from the TMS computer, an electronic notification message to the payee for the pending payment via the network data port.

23. The method of claim 1, further comprising the step of displaying, by the TMS computer, a list of invoices of the payee associated with the pending payment of the payer.

24. The method of claim 1, in response to selection by the payee of a payment status corresponding to approval of receipt of the payment, at the TMS computer system, storing the selected payment status in a payment records database associated with the TMS computer system.

25. The method of claim 1, wherein the payment recipient system is a payment receiving entity associated with the payee.

26. The method of claim 25, wherein the electronic payment instruction comprises an electronic check representation that is received and processed by a remote deposit capture (RDC) server associated with the payee's bank as payment receiving entity.

27. The method of claim 26, wherein the electronic payment instruction comprises an electronic check representation that is received and processed by a remote deposit capture (RDC) server associated with a third party payment entity not associated with the payee's bank, and thereafter paid by the third party payment entity to the payee in a manner indicated separately by the payee.

28. The method of claim 26, wherein the RDC server comprises a mobile RDC server.

29. The method of claim 1, wherein the electronic payment instruction comprises an electronic check representation that is a Check 21 Act compliant data file.

30. The method of claim 29, wherein the electronic payment instruction comprises an electronic check representation that is compliant with ANSI X9 standards.

31. A system for providing an electronic payment to a selected payee on behalf of a payer, the payer utilizing an accounting system that stores payments data corresponding to one or more payments to be made by the payer for electronic delivery to one or more payees, comprising:
a network-accessible transaction management system (TMS) computer including a processor;
a memory storing computer program code and a data file of payees associated with the payer, the data file of payees comprising payee identifying information and electronic payment opt-in status indicating assent by payees of receipt of electronic payments;
a data port for receiving payments data from the payer's accounting system;
a network data port for electronic communications with payers, payees, and a payment recipient system;
the processor operative for executing computer program code stored in the memory for:
(a) receiving payments data from a payer's accounting system including information corresponding to at least one pending payment to be made by the payer to at least one identified payee;
(b) processing the payments data to extract payee identification information and payment detail information;
(c) accessing the data file of payees to determine if extracted payee identification information for a pending payment corresponds to an existing payee in the data file and if so, to determine the opt-in status of the existing payee;
(d) in response to a determination that extracted payee identification information for the pending payment corresponds to an existing payee in the data file that possesses an opt-in status, generating an electronic payment instruction;
(e) in response to accessing of the TMS computer by the payee for the pending payment, displaying data corresponding to the electronic payment instruction to the payee;
(f) receiving a payment status command input by the payee in response to viewing the displayed electronic payment instruction, the payment status command comprising the selection by the payee of a predetermined payment status chosen by the payee for the pending payment; and
in response to selection by the payee of a payment status corresponding to approval of receipt of the payment, transmitting the electronic payment instruction to a payment recipient system for processing by the payment recipient system on behalf of the payee.

32. The system of claim 31, wherein the processor is further operative for executing program code for generating a new opt-out print file containing information corresponding to pending payments to be made by the payer to identified payees that correspond to an existing payee in the data file that possesses an opt-out status, and communicating the new opt-out print file to a printer for printing of paper checks.

33. The system of claim 31, wherein the processor is further operative for executing computer program code for displaying the electronic payment instruction to the payee is in response to selection of information relating to payment by a payee on a display of received payments.

34. The system of claim 31, wherein the payments data from the accounting system is an electronic print file.

35. The system of claim 31, wherein the electronic payment instruction comprises an electronic check representation corresponding to the payment detail information associated with the pending payment.

36. The system of claim 31, wherein the electronic payment instruction is provided to the payment recipient system as an electronic check.

37. The system of claim 31, wherein the system provides a payment to the selected payee on behalf of the payer, and comprises an integrated payment status management system on behalf of payers and payees that allows payees to electronically indicate a status with respect to a payment from a payer and that allows payers to electronically view status indicated by payees with respect to payments made by payers.

38. The system of claim 37, wherein the integrated payment status management system displays electronic check representations for viewing by payees, receives payment status indications by payees, and displays electronic check representations of viewing by payers, and displays payment status indications made by payees to payers.

39. The system of claim 31, wherein the transaction management system (TMS) computer is independent of the payer's accounting system, and is electronically coupled to the accounting system to electronically receive the payments data from the payer's accounting system.

40. The system of claim 31, wherein the processor is further operative for executing computer program code for maintaining a payment records database comprising information corresponding to payments from payers to payees utilizing the system.

41. The system of claim 40, wherein the payment records database stores information corresponding to opted-in as well as opted-out payments.

42. The system of claim 31, wherein the processor is further operative for executing computer program code for maintaining a check run mapping database storing information that allows parsing of the payments data from a particular payer's accounting system to extract predetermined information corresponding to pending payments from the payer.

43. The system of claim 42, wherein the predetermined information corresponding to pending payments from the payer comprises information including but not limited to: payee identification information, payee name, data, payment amount, bank routing number, payer bank account number, and payment remittance information.

44. The system of claim 42, wherein processing the payments data includes accessing the check run mapping database to obtain mapping information for extracting payee identification information.

45. The method of claim 31, wherein the processor is further operative for executing computer program code for, in response to a determination that extracted payee information in the payments data corresponds to a payee that has not indicated opt-in status or is not in the data file of payees,
generating an electronic print file including payment information for payees that do not possess opt-in status and omitting payees that possess opt-in status, and
communicating the electronic print file to a system for printing paper checks.

46. The system of claim 31, wherein the data corresponding to the electronic payment instruction comprises an electronic image of a check including but not limited to primary check information corresponding to a payee field, a data, an amount, a check number, a bank routing number, and a payer account number.

47. The system of claim 31, wherein the processor is further operative for executing computer program code for generating an electronic check representation for access by the payer and by the payee identified for the pending payment in response to a predetermined user action.

48. The system of claim 47, wherein the predetermined user action comprises selection by the payer or by the payee of information on a display screen corresponding to the pending payment.

49. The system of claim 47, wherein the electronic check representation is viewed by a payer or payee in response to selection by the payer or payee using a graphical user interface associated with the TMS computer.

50. The system of claim 47, wherein the electronic check representation includes, in addition to primary check information, remittance information corresponding to one or more invoices associated with the payee indicated by the payer for payment with the pending payment.

51. The system of claim 31, wherein the processor is further operative for executing computer program code for storing information corresponding to the pending payment in a payment records database for viewing and status indication by the payee and for viewing by the payer.

52. The system of claim 31, wherein the processor is further operative for executing computer program code for providing an electronic notification message to the payee for the pending payment via the network data port.

53. The system of claim 31, wherein the processor is further operative for executing computer program code for displaying a list of invoices of the payee associated with the pending payment of the payer.

54. The system of claim 31, wherein the processor is further operative for executing computer program code for, in response to selection by the payee of a payment status corresponding to approval of receipt of the payment, storing the selected payment status in a payment records database.

55. The system of claim 31, wherein the payment recipient system is a payment receiving entity associated with the payee.

56. The system of claim 55, wherein the electronic payment instruction comprises an electronic check representation that is received and processed by a remote deposit capture (RDC) server associated with the payee's bank as payment receiving entity.

57. The system of claim 55, wherein the electronic payment instruction comprises an electronic check representation that is received and processed by a remote deposit capture (RDC) server associated with a third party payment entity not associated with the payee's bank, and thereafter paid by the third party payment entity to the payee in a manner indicated separately by the payee.

58. The system of claim 57, wherein the RDC server comprises a mobile RDC server.

59. The system of claim 31, wherein the electronic payment instruction comprises an electronic check representation that is a Check 21 Act compliant data file.

60. The system of claim 59, wherein the electronic payment instruction comprises an electronic check representation that is compliant with ANSI X9 standards.
